(19) United States
(12) Patent Application Publication
(10) Pub. No.: US 2007/0080609 A1
(43) Pub. Date: Apr. 12, 2007

(54) Low loss ultrasound transducers

(75) Inventors: Benjaman R. Johnson, Jamestown, NY (US); Zhaoxia Cao, Jamestown, NY (US); Brian D. Bernhardt, Jamestown, NY (US); Kaustubh P. Marathe, Jamestown, NY (US); Gregory E. Phaneuf, Jamestown, NY (US); William L. Puskas, New London, NH (US)

Correspondence Address: PHILLIPS LYTLE LLP;INTELLECTUAL PROPERTY GROUP, 3400 HSBC CENTER, BUFFALO, NY, 14203-3509, US

(73) Assignee: Cleaning Technology Group LLC

(21) Appl. No.: 11/634,427

(22) Filed: Dec. 6, 2006

Related U.S. Application Data
(63) Continuation-in-part of application No. 11/115,768, filed on Apr. 27, 2005.
(63) Continuation-in-part of application No. 11/177,871, filed on Jul. 8, 2005.

(51) Int. Cl. H02N 2/00

(52) U.S. Cl. 310/323.04; 310/325

(57) ABSTRACT

An ultrasound transducer is constructed to be under damped at higher overtone frequencies by reducing losses through one or more of the following: even pressure shaped surfaces on masses, reversed drive to at least one piezoelectric ceramic, an ultrasonically formed metallic bond between the transducer's front mass and the radiating surface, high current carrying strain relieved electrodes, fine grain structure masses, low internal friction masses and radiating materials, and zero bias stress change due to temperature variations. Improved methods and construction details for bonding the higher overtone frequency transducer to quartz are disclosed and include: front masses with cross-hatched or concentric circle patterns and invar front masses or an invar transition mass that is bonded to the quartz.

### CROSS REFERENCE TO RELATED APPLICATIONS

This application is a continuation-in-part of, and claims priority to, commonly owned and co-pending U.S. patent application Ser. No. 11/115,768, filed Apr. 27, 2005 and entitled “High Power Ultrasonic Transducer,” and U.S. patent application Ser. No. 11/177,871, filed Jul. 8, 2005 and entitled “Low-Stress Ultrasound Transducer.” The entire contents of each of these applications is incorporated by reference herein.

### TECHNICAL FIELD

The present invention relates to ultrasound systems, and more particularly, to systems for generating high power ultrasonics energy and introducing the ultrasonics energy into fluid media for the purpose of cleaning and/or liquid processing.

### BACKGROUND ART

For years, ultrasonic energy has been used in manufacturing and processing plants to clean and/or otherwise process objects within liquids and to effect a process on a liquid. It is well known that objects may be efficiently cleaned by immersion in an aqueous solution and subsequent application of ultrasonic energy to the solution. Prior art ultrasound transducers include resonator components that are typically constructed of materials such as polarized piezoelectrics, ceramics, or magnetostrictives (aluminum and iron alloys or nickel and iron alloys). These resonator components are also referred to herein as active elements because they spatially oscillate at the frequency of an applied stimulating signal. The transducers are mechanically coupled to a tank containing a liquid that is formulated to clean or process the object of interest. The amount of liquid is adjusted to partially or completely cover the object in the tank, depending upon the particular application. When the transducers are stimulated to spatially oscillate, they transmit ultrasound into the liquid, and hence to the object. The interaction between the ultrasound-energized liquid and the object create the desired cleaning or processing action.

As shown in FIGS. 1A-1C, one type of prior art ultrasound transducer includes one or more resonator components compressed between a front plate and a back plate, with the compression typically established by a nut and bolt assembly, with the bolt extending from the back plate, through the back plate, resonator component(s) and the front plate and terminated by the nut adjacent to the front plate or terminated by a threaded bore in the front plate, which functions as a nut. FIG. 1A shows a cross-sectional exploded view when the transducer is not in a compression state and FIG. 1B shows a cross-sectional view of the transducer when the transducer is under a compression state. FIG. 1C schematically illustrates a chart of pressure on the surfaces of the resonator versus the radius R of the resonator. As shown in FIG. 1C, in these types of ultrasound transducers, the pressure applied by the front and back plates to the resonator is not evenly distributed across the surfaces of the resonator adjacent the plates, with higher pressure at regions close to the center of the discs and lower pressure at the peripheral regions of the discs. The non-evenly distributed pressure may reduce the reliability, capability, and life span of the transducer.

As shown in FIGS. 13A-13D, another description of prior art ultrasound transducer includes one or more resonator components compressed between a front plate and a back plate, with the compression typically established by a nut and bolt assembly, with the bolt extending from the back plate, through the back plate, resonator components and the front plate and terminated by the nut adjacent to the front plate or terminated by a threaded bore in the front plate, which functions as a nut. FIG. 13A shows a cross-sectional exploded view when the transducer is in a resting state, FIG. 13B shows a cross-sectional view of the transducer when the resonator components are driven by the stimulating signal to increase in thickness, FIG. 13C shows a cross-sectional view of the transducer when the resonator components are passing through the resting state position and FIG. 13D shows a cross-sectional view of the transducer when the resonator components are driven by the stimulating signal to decrease in thickness. These four figures can be related to one cycle of the driver stimulating signal waveform as the zero degree, 90 degree, 180 degree and 270 degree positions, respectively. Observation of the transducer backmass shows significant movement at the 90 degree and 270 degree positions. The compression bolt is stretched and the resonator components are stressed at the 90 degree position. This movement, stretching and stress causes loss in the transducer and this loss is particularly significant at high frequency overtones of the fundamental frequency.

State of the art sandwich type transducers, also known as Langevin type transducers, operate in the manner shown in FIGS. 13A to 13D. That is, the driven active elements, typically polarized piezoelectric ceramics, are driven to increase in thickness during one half cycle and driven to decrease in thickness during the next half cycle, resulting in the losses described above. These state of the art sandwich type transducers will be referred to herein as “resonant transducers” or “half wave resonant transducers” when used at their fundamental frequency and will be referred to as “harmonic transducers” when used at overtone frequencies.

A unidirectional single piston ultrasonic transducer as described in European Patent Application EP 1 060 798 A1, withdrawn Jul. 2, 2003, is a Langevin type transducer with a center mass that is driven up and down like a piston when one set of piezoelectric ceramics on one side of the center mass are driven to expand while another set of piezoelectric ceramics on the other side of the center mass are driven to compress.

### DISCLOSURE OF THE INVENTION

In general, one or more ultrasound generators drive one or more ultrasound transducers or arrays of transducers, in accordance with the embodiments described herein, coupled to a liquid to clean and/or process a part or parts, or to produce a processing effect on the liquid. The liquid is preferably contained within a tank, and the one or more ultrasound transducers mount on or within the tank to impart ultrasound into the liquid.

As defined in the technical literature, “ultrasound”, “ultrasonic” and “ultrasonics” generally refer to acoustic disturbances in a frequency range above about eighteen kilohertz (khz) and which extend upwards to over five megahertz (Mhz). As is commonly used in the cleaning industry and as used herein, “ultrasonic” will generally refer to acoustic disturbances in a frequency range above about eighteen kilohertz and extending up to about 99 khz. Ultrasound and ultrasonics will be used to mean the complete range of acoustic disturbances from about 18 khz to 5 Mhz, except when they are use with terms such as “lower frequency” ultrasound, “low frequency” ultrasound, “lower frequency” ultrasonics, or “low frequency” ultrasonics, then they will mean ultrasound between about 18 khz and 99 khz. “Megasonics” or “megasonic” refer to acoustic disturbances between about 351 khz and 5 Mhz. The prior art has manufactured “low frequency” and “megasonic” ultrasound systems. Typical prior art low frequency systems, for example, operate at 25 khz, 40 khz, and as high as 90 khz. Typical prior art megasonic systems operate between 600 khz and 2 Mhz. Certain aspects of the invention apply to low frequency ultrasound and to megasonics. However, certain aspects of the invention apply to ultrasound in the 100 khz to 350 khz region, a frequency range that is sometimes denoted herein as “microsonic” or “microsonics.”. The upper end of the microsonic frequency range from about 300 khz to 350 khz is called herein “higher microsonics” or “higher frequency microsonic”.

As used herein, “resonant transducer” means a transducer operated at a frequency or in a range of frequencies that correspond to a one-half wavelength (lambda) of sound in the transducer stack. “Harmonic transducer” means a transducer operated at a frequency or in a range of frequencies that correspond to 1 lambda, 1.5 lambda, 2 lambda or 2.5 lambda of sound, and so on, in the transducer stack. The harmonics of a practical physical structure are often not exact integer multiples of the fundamental frequency, the literature sometimes refer to these non-integer harmonics as overtones. Herein, harmonics will mean resonances higher in frequency than the fundamental resonant frequency. “Bandwidth” means the range of frequencies in a resonant or harmonic region of a transducer over which the acoustic power output of a transducer remains between 50% and 100% of the maximum value when driven by a constant voltage.

As used herein, “low-stress ultrasound transducer” means a transducer with two driven active elements and constructed such that the first driven active element is driven by a stimulating signal that is 180 degrees out of phase with the stimulating signal driving the second driven active element. The active elements that are driven by a stimulating signal will hereinafter be called “driven active elements”, note, a transducer may have active elements that are not driven during part or all of the time that a stimulating signal is applied to the transducer, these active elements during times that they are not driven will be called non-driven active elements or insulators. The term “polarized piezoelectric ceramic” will often be used herein interchangeably with driven active element, resonator, resonator component, resonator disc and disc resonators. This operation of the driven active elements within a low-stress ultrasound transducer typically causes a canceling or suppression effect at a frequency or in a range of frequencies that correspond to one-half wavelength of sound in the transducer stack. Therefore, when referring to a low-stress ultrasound transducer, fundamental frequency will mean the lowest frequency at which the assembly will resonate and harmonics, harmonic frequencies or overtones will mean resonances higher in frequency than the fundamental frequency. Bandwidth means the range of frequencies in the fundamental or a harmonic region of a low-stress ultrasound transducer over which the acoustic power output of the low-stress ultrasound transducer remains between 50% and 100% of the maximum value.

As used herein, “hz” refers to hertz which is cycles per second, “khz” refers to kilohertz and a frequency magnitude of one thousand hertz. “Mhz” refers to megahertz and a frequency magnitude of one million hertz.

As used herein, “stimulating signal” is generally an AC voltage at a frequency or in a range of frequencies that correspond to the bandwidth surrounding a fundamental or overtone frequency. A stimulating signal may be a fixed frequency, or it may sweep frequency. Sweeping frequency stimulating signals are typically obtained at the output of sweeping frequency generators. The simplest stimulating signal is single phase, that is, two wires or two connections supplying a single frequency voltage or sweeping frequency voltage. This invention uses single phase stimulating signals, but also uses multiple phase stimulating signals. For example, a split phase stimulating signal has two voltages that are 180 degrees out of phase and that are typically supplied on three wires or three connections. This split phase stimulating signal is often obtained at the output of a center tapped transformer. Three phase stimulating signals that are three voltages 120 degrees out of phase with each other are also used herein. In general, an n phase stimulating signal where n is an integer is applicable to this invention. This n phase stimulating signal has n voltages that are 360 divided by n degrees out of phase with each other.

As used herein, successive frequencies are said to “sweep” when the period or the half period of two or more of the waveforms are unequal to each other.

Sweeping frequency generators change their output frequency through successive frequencies in a bandwidth, e.g., sweeping from the lowest frequency in a chosen bandwidth through the bandwidth to the highest frequency in the chosen bandwidth, then sweeping from this highest frequency through the bandwidth back to the lowest frequency. The function of time for these frequency changes is typically linear, but other functions of time, such as part of an exponential, are possible. As used herein, “sweep frequency” refers to the reciprocal of the time that it takes for successive frequencies to make a round trip, for example, change from one frequency through the other frequencies and back to the original frequency. Although sweep rate might technically be interpreted as the rate of change from one successive frequency to the next, the more common usage for sweep rate will be used herein; that is, “sweep rate” means the same as sweep frequency. It is generally undesirable to operate an ultrasound transducer at a fixed, single frequency because of the resonances created at that frequency. Therefore, an ultrasound generator can sweep the operational frequency through some or all of the available frequencies within the transducer's bandwidth at a “sweep rate.” Accordingly, particular frequencies have only short duration during the sweep cycle (i.e., the time period for sweeping the ultrasound frequency up and down through a range of frequencies within the bandwidth). “Sweep the sweep rate” or “double sweeping” or “dual sweep” refer to an operation of changing the sweep rate as a function of time so that the sweep rate is non constant. “Random sweep rate” or “chaotic sweep rate” refer to sweep rates where the successive sweep rates are numbers that are described by no well defined function, i.e., random or chaotic numbers.

The “resonator or resonator assembly” refers to the central components compressed between the front mass and the back mass in a sandwich type transducer. These central components typically include two or more driven active elements and one or more electrodes. In some embodiments the central components may also include one or more insulators (some of which may be non driven active elements), one or more heatsinking elements or electrodes that also can be used as heatsinking elements.

The present invention concerns the applied uses of ultrasound energy, and in particular the application and control of ultrasonics to clean and/or process parts within a liquid, or to impart a processing effect on the liquid. Generally, in accord with the invention, one or more ultrasound generators drive one or more ultrasound transducers, or arrays of transducers, coupled to a liquid to clean and/or process the part. The liquid is preferably held within a tank; and the transducers mount on or within the tank to impart ultrasound into the liquid. In this context, the invention is particularly directed to one or more of the following aspects and advantages:

According to one aspect of the present invention, the transducer includes a resonator assembly having a first surface and a second surface on opposite sides thereof, a front mass having a surface adjacent to the first surface of the resonator assembly, a back mass having a surface adjacent to the second surface of the resonator assembly, and a compression assembly mounted on the front mass and the back mass. The compression assembly is adapted to fasten the front and back masses, biasing those masses toward each other and thereby effecting compression across the resonator assembly. In one preferred form, at least one of the surfaces of the front mass and the back mass adjacent the resonator is curved when the compression assembly is not in the compression state, and when the compression assembly effects the compression across the resonator assembly, the transducer has a substantially constant pressure across the surfaces of the resonator assembly. In an alternative form, at least one of the first and second surfaces of the resonator assembly is curved when the compression assembly is not in the compression state, and when the compression assembly effects the compression across the resonator assembly, the transducer has a substantially constant pressure across the first and second surfaces of the resonator assembly.

According to one aspect of the present invention, the transducer includes a resonator assembly having a first surface and a second surface on opposite sides thereof, a front mass having a surface adjacent to the first surface of the resonator assembly, a back mass having a surface adjacent to the second surface of the resonator assembly, and a compression assembly mounted on the front mass and the back mass. The compression assembly is adapted to fasten the front and back masses, biasing those masses toward each other and thereby effecting compression across the resonator assembly. In one preferred form, one of the two driven active elements of a resonator assembly is reversed in polarity compared to known sandwich type transducers such that the first driven active element is driven by a stimulating signal that is 180 degrees out of phase with the stimulating signal driving the second driven active element

In an alternative form, the resonator assembly components are wired to a switching device such as a relay which allows them to act as in a known sandwich type half wave resonant transducer during one state of the relay, i.e., the driven active elements all are driven to increase in thickness during one half cycle and all are driven to decrease in thickness during the next half cycle, and to act in the inventive way in the other state of the relay, i.e., the first driven active element is driven by a stimulating signal that is 180 degrees out of phase with the stimulating signal driving the second driven active element.

It is known to a person skilled in the art of ultrasound transducer design that electrodes are needed in the aspects of the invention described above and in aspects of the invention described later in this specification. In a known sandwich type resonant transducer or in the various forms of the inventive low-stress ultrasound transducer, there are many ways and positions in which to realize the needed electrodes. For example, in one of the simplest sandwich transducer designs containing two driven active elements, a back mass, a front mass, a compression assembly and driven by a single stimulating signal supplied by two wires, there are at least four different configurations of electrodes known to one skilled in the art and any of these might be employed in the design of a given transducer. Configuration one has one center electrode between the two driven active elements. Electrical contact is made to this electrode from the first wire from the stimulating signal and the second wire from the stimulating signal is connected to either the front mass or the back mass, or in the case that the radiating diaphragm is in electrical contact with the front mass, this second wire from the stimulating signal can be connected to the radiating diaphragm. Configuration two has a center electrode between the two driven active elements and a second electrode between the front mass and the surface of the driven active element that is adjacent to the front mass. The stimulating signal wires are connected to these two electrodes. Contact to the driven active element surface adjacent to the back mass is made by the electrical contact from the front mass, through the compression assembly, to the back mass which contacts the driven active element surface adjacent to the back mass. Configuration three has a center electrode between the two driven active elements and a second electrode between the back mass and the surface of the driven active element that is adjacent to the back mass. The stimulating signal wires are connected to these two electrodes. Contact to the driven active element surface adjacent to the front mass is made by the electrical contact from the back mass, through the compression assembly, to the front mass which contacts the driven active element surface adjacent to the front mass. Configuration four has a center electrode between the two driven active elements, a second electrode between the back mass and the surface of the driven active element that is adjacent to the back mass, and a third electrode between the front mass and the surface of the driven active element that is adjacent to the front mass. Electrical contact is made to the center electrode from the first wire from the stimulating signal and the second wire from the stimulating signal is connected to electrodes two and three. Since electrode configurations are well known to those skilled in the art and since there are many variations of electrode configurations that accomplish the same function, in this specification and in the claims of this invention the electrode configuration will sometimes be eliminated or partially defined where clarity results. It should be understood that the needed electrodes that are not detailed could be any of the many configurations known to those skilled in the art. It should also be understood that when adjacent surfaces are described, for example, “wherein said two polarized piezoelectric ceramics are arranged with said positive polarity surface of said first polarized piezoelectric ceramic adjacent to said negative polarity surface of said second polarized piezoelectric ceramic”, there may be an electrode between these adjacent surfaces. For purposes of clarity herein, the described surfaces are still considered to be adjacent when there is an electrode between them, even when this electrode is not detailed and simply assumed as one included as part of the many possible electrode configurations. In the specific example given, there would be an electrode between the two polarized piezoelectric ceramics, i.e., the center electrode, and any of the four electrode configurations described above would be applicable for this example.

Various aspects of the low-stress ultrasound transducer can be implemented without the use of a center electrode. One example of this aspect of the invention has two driven active elements, one stacked on top of the other, with electrodes at the opposite ends of the stack. An insulator is typically needed at one end of this electrode and active element stack to prevent the back mass, compression assembly and front mass from shorting out the electrodes. The driven active elements are oriented such that when the electrodes are driven by a stimulating signal, one of the driven active elements is driven to increase in thickness while the other driven active element is driven to decrease in thickness. With this configuration of electrodes, the capacitance of driven active elements is in series, making the total transducer capacitance substantially one quarter the value of the value that results with one of the other four electrode configurations. This has the advantage of reducing current necessary from the stimulating signal source, a feature particularly valuable at frequencies in the higher microsonics or megasonic frequency ranges.

According to another aspect of the present invention, the tank bottom or other radiating surface is also used as the front plate or front mass of the transducer assembly, therefore, the compression assembly is mounted on the radiating surface and the back mass. The two or more driven active elements within the resonator assembly operate in the inventive way, i.e., a transducer with two driven active elements is constructed such that the first driven active element is driven by a stimulating signal that is 180 degrees out of phase with the stimulating signal driving the second driven active element.

This new arrangement of the components that are driven active elements was not previously envisioned by those skilled in the state of the art because it causes a canceling of the half wave resonator effect at the fundamental half wave frequency of a sandwich type transducer. This effect was previously thought to be necessary for the operation of this type of transducer. However, the inventor of this new arrangement was able to visualize low stress and therefore low loss operation at overtone frequencies when one or more of the components that are driven active elements was arranged so a transducer with two driven active elements and constructed such that the first driven active element is driven by a stimulating signal that is 180 degrees out of phase with the stimulating signal driving the second driven active element. He theorized that this effect would reduce motion of the bolt and other components within the transducer assembly and reduce stress within the driven active elements within the resonator assembly; therefore, reducing friction and other losses associated with these motions. This reduced loss would allow higher overtone frequencies that were over damped in prior state of the art transducers to become under damped and usable in this new low-stress ultrasound transducer. The inventor did experimentation to verify his theory and found that operation into the higher microsonics and the megasonic frequencies was possible with this new sandwich transducer construction.

According to one preferred embodiment, the resonator assembly includes at least two driven active elements. According to another preferred embodiment, the resonator assembly includes three or more driven active elements placed one on top of the other.

According to another preferred embodiment, the compression assembly is mounted on central regions of the front and back masses. In one preferred form, the compression assembly includes a bias bolt and nut assembly, and the front mass, the resonator assembly, and the back mass define a bore extending along a central axis of the front mass, the resonator assembly, and the back mass for receiving the bolt. In some embodiments, the bolt is adapted to pass through the central bore of the stacked back mass, resonator assembly and front mass, and the nut is a discrete element, which is screwed onto a lead end of the bias bolt. In other embodiments, the bore defined in the front mass includes threads on an inner surface of said bores, and the lead end of the bias bolt is screwed into the threaded bore in the front mass, so that the front mass acts as the “nut”. The bolt can extend from the front mass to a nut in or adjacent to the back mass or it can extend from the back mass to a nut adjacent to or within the front mass. The bias bolt and nut adjustably engage the back mass and the front mass so as to compress the two or more polarized piezoelectric ceramics between the back mass and the front mass.

With the compression assembly mounted on the central regions of the front and back masses, the at least one curved surface is preferably concave-shaped, such that, in assembly, as the compression assembly is tightened to effect compression across the resonator assembly, the peripheral region of the concave-shaped element physically interacts first with surface of the opposing element, and as the compression assembly is tightened to establish desired compression on the resonator assembly, the masses establish a pressure on the resonator assembly that is substantially uniform across the adjacent surfaces of the masses and resonator assembly.

In one preferred embodiment, the surface of the front mass adjacent the resonator assembly and the surface of the back mass adjacent the resonator assembly are concave-shaped. In another preferred embodiment, the first and second surfaces of the resonator assembly are concave-shaped. Other combinations of concave surfaces may be used as well, so that upon compression a substantially constant pressure is achieved across the resonator surface(s).

According to another aspect of the present invention, the compression assembly is mounted on peripheral regions of the front mass and the back mass. In one preferred form, the compression assembly includes at least two bolt and nut assemblies, and the front mass and the back mass define at least two bores at peripheral regions extending along axes parallel to a central axis of the front mass and the back mass for receiving the at least two bolts. The nut can be a discrete element that is adapted to be screwed on a lead end of a corresponding bolt, or alternatively, the bore in the front mass includes threads on an inner surface for engaging the threads on the lead end of the bolt, such that the front mass functions as the “nut”. The bias bolts adjustably engage the back mass and the front mass so as to compress the two or more polarized piezoelectric ceramics between the back mass and the front mass.

With the compression assembly mounted on peripheral regions of the front and back masses, the at least one curved surface is preferably convex-shaped, such that, in assembly, as the compression assembly is tightened to effect compression across the resonator assembly, the central region of the convex-shaped element physically interacts first with surface of the opposing element, and as the compression assembly is tightened to establish desired compression on the resonator assembly, the masses establish a pressure on the resonator assembly that is substantially uniform across the adjacent surfaces of the masses and resonator assembly.

According to one preferred embodiment, the surface of the front mass adjacent the resonator assembly and the surface of the back mass adjacent the resonator assembly are convex-shaped. According to another preferred embodiment, the first and second surfaces of the resonator assembly are convex-shaped. Other combinations of convex surfaces may be used as well, so that upon compression a substantially constant pressure is achieved across the resonator surface(s).

The transducer may further include insulators disposed between the bolt and the resonator assembly, and electrodes connected to the resonator assembly.

According to a further aspect of the present invention, the sandwich type ultrasound transducer preferably has a low-density back mass (i.e., aluminum, magnesium, etc.) and is used to produce a device with an especially wide bandwidth. This large bandwidth allows effective sweeping over a dramatically larger range of frequencies. This sweeping can be conventional linear sweep or one of the non constant sweeps known as double sweeping, dual sweep, random sweep, or chaotic sweep. A low-density back mass provides a larger surface area compared to that of a prior art steel back mass of the same acoustic length. This increased surface area also allows higher heat dissipation per transducer that in turn allows a higher overall power output at the overtone frequencies.

According yet another aspect of the present invention, the resonators are made from ceramic, preferably non-silvered polarized piezoelectric ceramic. Elimination of the oft-applied silver to the faces of the polarized piezoelectric ceramic is accomplished through a lapping process that ensures extreme flatness of the polarized piezoelectric ceramics. These flat non-silvered surfaces optimize utilization for high power applications. A transducer characterized by an especially high bandwidth may or may not contain non-silvered polarized piezoelectric ceramics. An example of another improvement is the incorporation of multiple concentric ceramic polarized piezoelectric elements in place of the solid ceramic polarized piezoelectric discs often used. In one application the size and geometry of these concentric cylindrical shells are tailored to ensure that the radial resonant frequencies of the polarized piezoelectric ceramics do coincide with that of the transducer assembly for maximized output at that frequency. In another application these concentric rings are tailored to ensure that the radial resonant frequencies of the polarized piezoelectric ceramics do not coincide with that of the transducer assembly to minimize strain at those frequencies. These polarized piezoelectric ceramics can be silvered or lapped free of silver.

According to another aspect of the present invention, another improvement of the transducer is a deviation from cylindrical symmetry on any of the components for the reason of yielding a device of extreme bandwidth as well as the manipulation/elimination of radial resonant frequencies. An example of this deviation from cylindrical symmetry includes slots on the sides of the front mass or elliptical masses. If properly implemented, deviation from cylindrical symmetry, including the addition of flats or slots on the sides of the high power ultrasound transducer front mass, can result in a device with exceptionally large bandwidth. In a similar way to concentric ceramics, it can also result in a transducer having radial resonance frequencies that are tailored with respect to the rest of the frequency spectrum, specifically the longitudinal resonance. Large bandwidth allows effective sweeping over a dramatically larger range of frequencies. This transducer is designed specifically to have as flat an impedance verses frequency curve as possible in the region of said transducer's resonance, or any of its overtones. This design feature is intended to maximize the benefits obtained from the sweeping of frequencies within some bandwidth about some center frequency. Sweeping frequency, the most primitive type of frequency modulation (FM), has had a major impact on the ultrasonic cleaning industry over the last twelve years. When done correctly, it improves the performance of an ultrasonic cleaner and generally reduces the damage to delicate parts caused by constant frequency ultrasonics. Introducing a change in the frequency, as a function of time, of an ultrasonic array can effect what happens in a tank in a number of ways. This includes how energy is transferred to the fluid, how efficiently that sound energy is converted into cavitational energy, and how energy is transferred to a part. Once a certain amount of ultrasonic energy has been transferred to the fluid medium one must examine how much of that energy is expressed in the form of cavitation. An effective way of representing this is with a mathematical tool known as the acoustic interaction cross-section. The acoustic interaction cross-section is given by the ratio of the time-averaged power subtracted from an incident acoustic wave as a result of the presence of a bubble, of some size R, to the intensity of the incident acoustic wave. Simply, this is the amount of energy subtracted from an incident acoustic wave by a bubble driven into oscillation. This energy is subsequently re-radiated by the bubble via pulsation or implosion and affects much of the cleaning accomplished by ultrasonics. As its name suggests, acoustic interaction cross-section has the units of area, i.e., square meters.

In yet another preferred aspect of the present invention a series resonator assembly for use in a sandwich type transducer driven by a stimulating signal consists of a first polarized piezoelectric ceramic and a second polarized piezoelectric ceramic stacked one on top of the other; and two electrodes at the opposite ends of the polarized piezoelectric stack to couple the stimulating signal to the polarized piezoelectric stack. Wherein the first polarized piezoelectric ceramic has a positive polarity surface and a negative polarity surface on opposite sides thereof, and wherein the second polarized piezoelectric ceramic has a positive polarity surface and a negative polarity surface on opposite sides thereof, and wherein the two polarized piezoelectric ceramics are arranged with the positive polarity surface of the first polarized piezoelectric ceramic adjacent to and in electrical contact with the positive polarity surface of the second polarized piezoelectric ceramic forming a series connection of the two polarized piezoelectric ceramics.

In yet another preferred aspect of the present invention a series resonator assembly for use in a sandwich type transducer driven by a stimulating signal consisting of a first polarized piezoelectric ceramic and a second polarized piezoelectric ceramic stacked one on top of the other; and two electrodes at the opposite ends of the polarized piezoelectric stack to couple the stimulating signal to the polarized piezoelectric stack. Wherein the first polarized piezoelectric ceramic has a positive polarity surface and a negative polarity surface on opposite sides thereof, and wherein the second polarized piezoelectric ceramic has a positive polarity surface and a negative polarity surface on opposite sides thereof, and wherein the two polarized piezoelectric ceramics are arranged with the negative polarity surface of the first polarized piezoelectric ceramic adjacent to and in electrical contact with the negative polarity surface of the second polarized piezoelectric ceramic forming a series connection of the two polarized piezoelectric ceramics.

In yet another preferred aspect of the present invention a resonator assembly with two modes of operation for use in a sandwich type transducer assembly and a two state switching system driven by a stimulating signal consisting of a stimulating signal delivered between lead one and lead two; a first polarized piezoelectric ceramic with a positive polarity on one side and a negative polarity on the other side; a second polarized piezoelectric ceramic with a positive polarity on one side and a negative polarity on the other side; a center electrode with one side adjacent to the negative polarity side of the first polarized piezoelectric ceramic and with the other side of the center electrode adjacent to the negative polarity side of the second polarized piezoelectric ceramic; a second electrode adjacent to the positive polarity side of the first polarized piezoelectric ceramic; a third electrode adjacent to the positive polarity side of the second polarized piezoelectric ceramic; an insulating means to prevent the sandwich type transducer assembly from electrically shorting the second electrode to the third electrode; a series mode of the resonator assembly where lead one of the stimulating signal is connected to the second electrode and lead two of the stimulating signal is connected to the third electrode; a parallel mode of the resonator assembly where lead one of the stimulating signal is connected to the center electrode and lead two of the stimulating signal is connected to both of the second and third electrodes; and a switching system with a first state and a second state. Wherein, when the switching system is in the first state, the stimulating signal is connected to the series mode of the resonator assembly, and wherein, when the switching system is in the second state, the stimulating signal is connected to the parallel mode of the resonator assembly.

In yet another preferred aspect of the present invention a resonator assembly with two modes of operation for use in a sandwich type transducer assembly consisting of a first polarized piezoelectric ceramic with a positive polarity on one side and a negative polarity on the other side; a second polarized piezoelectric ceramic with a positive polarity on one side and a negative polarity on the other side; a center electrode with one side adjacent to the negative polarity side of the first polarized piezoelectric ceramic and with the other side of the center electrode adjacent to the negative polarity side of the second polarized piezoelectric ceramic; a second electrode adjacent to the positive polarity side of the first polarized piezoelectric ceramic; a third electrode adjacent to the positive polarity side of the second polarized piezoelectric ceramic; and an insulating means to prevent the sandwich type transducer assembly from electrically shorting the second electrode to the third electrode. Wherein a series mode of the resonator assembly is formed when a first electrical connection is made to the second electrode and when a second electrical connection is made to the third electrode to realize one set of frequency ranges; and, wherein a parallel mode of the resonator assembly is formed when a first electrical connection is made to the center electrode and a second electrical connection is made to both of the second and third electrodes to realize a second set of frequency ranges.

In another embodiment of the invention, a sandwich type ultrasound transducer driven by at least one stimulating signal comprises a resonator assembly having a first surface and a second surface on opposite sides thereof and containing at least two driven active elements; a front mass having a surface adjacent to the first surface of the resonator assembly; a back mass having a surface adjacent to the second surface of the resonator assembly; electrodes to couple the at least one stimulating signal to the at least two driven active elements; a compression assembly coupling the front mass and the back mass, and adapted to effect a compression across the resonator assembly. Each of the driven active elements has a positive polarity on one surface, wherein at a point in time, at least one of the at least two driven active elements is driven with a positive voltage on the surface with a positive polarity while at least one of the other of the at least two driven active elements is driven with a negative voltage on the surface with a positive polarity when the ultrasound transducer is driven by the at least one stimulating signal.

In another aspect of the present invention the number of driven active elements can be odd and the effects of a reversed drive voltage configuration realized with phase shifting of the stimulating voltages. For example, when there are three driven active elements in the low-stress ultrasound transducer and each is driven by one of three stimulating signals where each is shifted 120 degrees from each other, the suppression of the half wave resonant frequency of the sandwich structure is accomplished because (sin(wt+0))+(sin(wt+2*PI/3))+(sin(wt+4*PI/3))=0 for any specified angular frequency w or any time t. This aspect of the present invention is applicable to any number of phase shifted stimulating signals greater than one and a like number times any integer of driven active elements. This condition of the displacement of the driven active elements adding up to zero for all times with phase shifted stimulating signals will be referred to herein as a “zero displacement phase shifted drive voltages configuration”. This zero displacement phase shifted drive voltages configuration suppresses the half wave resonant frequency of the sandwich structure and results in low loss and frequencies above the half wave resonant frequency of the sandwich structure.

According to another aspect of the present invention, an ultrasonic metal welding apparatus with three horns is employed to metal weld a transducer front mass to a tank, where the horns are spaced 120 degrees around the transducer front mass and the drive signals to the horns are 120 degrees out of phase with each other to give a circular bonding motion.

According to yet another aspect of the present invention, one or more metal components in a Langevin transducer are replaced with niobium, maraging steel, single crystal silicon or other low internal friction material to reduce losses and obtain higher frequencies.

According to another aspect of the present invention, crimped electrodes with strain relief are employed to reliably handle the higher currents that occur when generating higher frequency ultrasound.

According to yet another aspect of the present invention, an invar front driver or an invar interface between a transducer and a quartz tank is used to allow direct bonding to quartz without cracking of the quartz due to large thermal expansion differences.

According to another aspect of the present invention, the tank, immersible or the radiating surfaces of these structures are made with low internal friction sheet metal materials, e.g., maraging steel, to obtain efficient operation of thicker tanks and immersibles at higher frequencies.

According to another aspect of the present invention, mathematical design parameters based on the thermal expansion coefficients of the transducer materials are used, resulting in zero static pressure change on the piezoelectric ceramic when transducer temperature is changed.

According to yet another aspect of the present invention, transducer mechanical bias is supplied by a collar that threads onto external threads located on the OD of the front driver.

According to another aspect of the present invention, an external thermally conductive collar similar to that described above has the purpose of conducting heat from the back mass to the front mass where the heat can be removed by the tank and its liquid.

According to yet another aspect of the present invention, a thermally conductive substance, e.g., a gel, is built into the center cavity of a center bolt Langevin transducer such that the thermally conductive substance conducts heat from the ID of the ceramics and from the back mass to the front mass.

According to another aspect of the present invention, a center bolt Langevin type transducer that has a back mass, a front mass and a middle mass where the middle mass conducts heat from the two ceramic surfaces that are normally adjacent. This extra heat conduction path results in more uniform temperature distribution within each ceramic resulting in higher reliability.

According to another aspect of the present invention, a three mass Langevin type transducer like described above has a concave shape to the four mass surfaces that contact the piezoelectric surfaces to improve reliability by applying equal pressure across the piezoelectric surfaces.

According to yet another aspect of the present invention, a transducer made with a conventional material front mass such as aluminum is modified by cutting a grid or concentric circles into the surface of the front mass where it is bonded. This relieves stress on tank materials such as quartz during differential thermal expansion.

According to another aspect of the present invention, a nut or threaded insert is cast into an aluminum front mass to minimize thread creep compared to that which occurs with softer aluminum threads.

According to another aspect of the present invention, metal masses with fine grain structure are employed to minimize attenuation of sound waves.

The invention is next described further in connection with preferred embodiments, and it will become apparent that various additions, subtractions, and modifications can be made by those skilled in the art without departing from the scope of the invention.

The foregoing and other objects of this invention, the various features thereof, as well as the invention itself, may be more fully understood from the following description, when read together with the accompanying drawings in which:

### BRIEF DESCRIPTION OF THE DRAWINGS

FIG. 1A shows a cross-sectional exploded view of a prior art transducer.

FIG. 1B shows a cross-sectional view of the prior art transducer in FIG. 1A when the transducer is under a compression state.

FIG. 1C schematically shows a chart of pressure on the surface of a resonator versus the radius of the resonator of the prior art transducer in FIGS. 1A and 1B.

FIG. 2 shows a perspective view of a transducer according to one preferred embodiment of the present invention.

FIG. 3 shows a top view of the transducer in FIG. 2.

FIG. 4A shows a cross-sectional exploded view of a transducer according to one preferred embodiment of the present invention.

FIG. 4B shows a cross-sectional view of the transducer in FIG. 4A when the transducer is under a compression state.

FIG. 4C schematically shows a chart of pressure on the surface of a resonator versus the radius of the resonator of the transducer in FIGS. 4A and 4B.

FIG. 5A shows a cross-sectional exploded view of a transducer according to another preferred embodiment of the present invention.

FIG. 5B shows a cross-sectional view of the transducer in FIG. 5A when the transducer is under a compression state.

FIG. 5C schematically shows a chart of pressure on the surface of a resonator versus the radius of the resonator of the transducer in FIGS. 5A and 5B.

FIG. 6A shows a cross-sectional exploded view of a transducer according to another preferred embodiment of the present invention.

FIG. 6B shows a cross-sectional view of the transducer in FIG. 6A when the transducer is under a compression state;

FIG. 6C schematically shows a chart of pressure on the surface of a resonator versus the radius of the resonator of the transducer in FIGS. 6A and 5B.

FIG. 7A shows a cross-sectional exploded view of a transducer according to another preferred embodiment of the present invention.

FIG. 7B shows a cross-sectional view of the transducer in FIG. 7A when the transducer is under a compression state.

FIG. 7C schematically shows a chart of pressure on the surface of a resonator versus the radius of the resonator of the transducer in FIGS. 7A and 7B.

FIG. 8A shows a cross-sectional exploded view of a transducer according to another preferred embodiment of the present invention.

FIG. 8B shows a cross-sectional view of the transducer in FIG. 8A when the transducer is under a compression state.

FIG. 8C schematically shows a chart of pressure on the surface of a resonator versus the radius of the resonator of the transducer in FIGS. 8A and 8B.

FIG. 9 schematically shows a side view of a front mass and a back mass of a transducer according to one preferred embodiment of the present invention.

FIG. 10 schematically shows a side view of a front mass and a back mass of a transducer according to another preferred embodiment of the present invention.

FIG. 11 schematically shows a side view of a front mass and a back mass of a transducer according to a further preferred embodiment of the present invention.

FIG. 12A shows a front mass that deviates from cylindrical symmetry by including lateral slots, parallel to the central axis AX.

FIG. 12B shows a front mass that deviates from cylindrical symmetry by including an elliptical cross section in a plane perpendicular to the central axis AX.

FIG. 12C shows a front mass that deviates from cylindrical symmetry by including flat regions along the outer surface of the front mass, running parallel to the central axis AX.

FIG. 13A shows a cross-sectional view of a prior art transducer in a resting state.

FIG. 13B shows a cross-sectional view of the prior art transducer in FIG. 13A when the transducer is driven to 90 degrees of the stimulating signal.

FIG. 13C shows a cross-sectional view of the prior art transducer in FIG. 13A when the transducer is driven to 180 degrees of the stimulating signal.

FIG. 13D shows a cross-sectional view of the prior art transducer in FIG. 13A when the transducer is driven to 270 degrees of the stimulating signal.

FIG. 14A shows a cross-sectional view of a transducer according to one preferred embodiment of the present invention.

FIG. 14B shows a cross-sectional view of the transducer in FIG. 14A when the transducer is driven to 90 degrees of the stimulating signal.

FIG. 14C shows a cross-sectional view of the transducer in FIG. 14A when the transducer is driven to 180 degrees of the stimulating signal.

FIG. 14D shows a cross-sectional view of the transducer in FIG. 14A when the transducer is driven to 270 degrees of the stimulating signal.

FIG. 15 schematically shows a series and parallel resonator assembly with a switching device to obtain two modes of operation.

FIG. 16 shows a diagram of an ultrasonic metal welding apparatus for bonding a transducer to a metal radiating surface.

FIG. 17 shows a drawing of an electrode constructed according to the invention prior to forming the crimps.

FIG. 18 shows a drawing of an electrode constructed according to the invention after forming the crimps.

FIG. 19 shows a drawing of an ultrasound transducer with an external collar.

FIG. 20 shows a cross-sectional diagram of a transducer with a middle mass.

FIG. 21 shows an exploded cross-sectional diagram of a transducer with a middle mass and concave surfaces on the three masses.

FIG. 22A shows a transducer front mass with a grid cut into the bonding surface.

FIG. 22B shows a transducer front mass with concentric circles cut into the bonding surface.

FIG. 23A shows a picture of grain structure of aluminum typically used in Langevin transducers.

FIG. 23B shows a picture of grain structure of aluminum with improved grain structure according to the invention.

FIG. 24 shows a transducer designed for zero stress change on the piezoelectric ceramics when temperature is changed.

### DESCRIPTION OF THE PREFERRED EMBODIMENTS

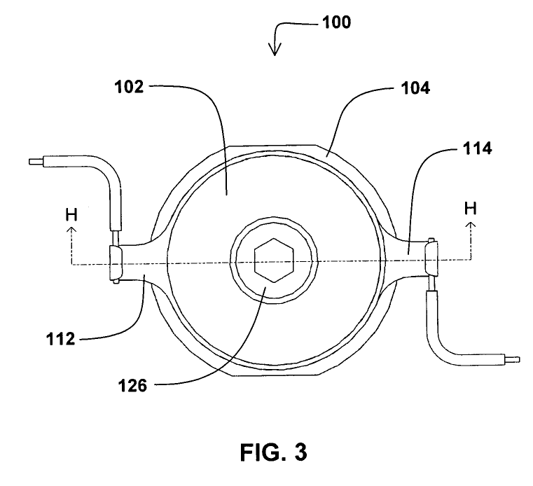

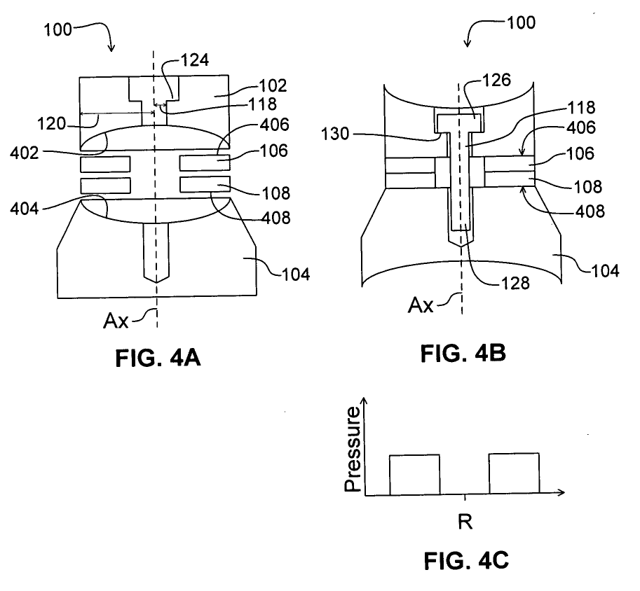

FIG. 2 shows a perspective view of one preferred embodiment of an ultrasound transducer 100 and FIG. 3 shows a top view of the transducer 100 of FIG. 2. FIGS. 4A and 4B show cross-sectional views (section H-H from FIG. 3) of the transducer 100 of FIG. 2, FIG. 4A depicting an exploded view to show the parts of the transducer 100 and FIG. 4B depicting a cross-sectional view of the transducer 100 when the transducer is under a compressed state. The transducer 100 employs a Langevin architecture, also known in the art as a sandwich transducer. According to one aspect of the invention, the transducer 100 includes a back mass 102, a front mass 104, a resonator assembly including a first ceramic disc resonator 106 and a second ceramic disc resonator 108, and a compression assembly including a central bias bolt 116. The transducer may further include an insulator, which is not shown in the drawings, disposed between the bolt 116 and the disc resonators 106 and 108, and electrodes 112 and 114 (as shown in FIG. 3) connected to the disc resonators 106 and 108. In the embodiment of FIGS. 2, 3, 4A and 4B, the back mass 102, front mass 104, first ceramic disc 106 and second ceramic disc 108 are each characterized by a substantially annular shape extending about a central axis AX, and characterized by an inner radius 118 and an outer radius 120. The inner radius 118 and outer radius 120 are shown in FIG. 4A for the back mass 102 only. Each of the other components (the front mass 104 and the ceramic discs 106 and 108 is characterized by a corresponding inner radius and outer radius, which may or may not be the same as the other components in the transducer 100. The inner radius 118 of the back mass 102 undergoes an abrupt change near the back end, forming a shelf 124 in the inner bore.

In the embodiment shown in FIGS. 4A and 4B, the bore of the front mass 104, characterized by the inner radius of the front mass 104, does not extend completely through the front mass 104 along the axis AX. Other embodiments may include an inner bore of the front mass 104 that extends completely through the front mass 104. The front mass 104 further includes threads on the walls of the inner bore. In one preferred embodiment, the threads are machined into the inner bore, although other techniques known in the art may also be used to create threads in the inner bore.

The back mass 102, front mass 104, first ceramic disc 106 and second ceramic disc 108 are stacked so as to be adjacent and disposed along the common central axis AX, as shown in FIGS. 4A and 4B. The first ceramic disc 106 and the second ceramic disc 108 are “sandwiched” between the back mass 102 and the front mass 104. The bias bolt 116 is preferably symmetrically disposed about the common axis AX, and includes a first end 126 and a second end 128. The outer radius near first end 126 is characterized by an abrupt change, forming a shelf 130. The second end 128 includes threads along the outer surface for mating with the threads on the walls of the inner bore of the front mass 104. The transducer 100 is assembled by passing the bias bolt 116 through the bore of the back mass 102, the bore of the first ceramic disc 106, the bore of the second ceramic disc 108, and into the bore of the front mass 104. The threads on the bias bolt 116 engage the threads in the bore of the front mass 104. As the bias bolt 116 is tightened, the bias bolt 116 is drawn into the bore of the front mass 104, and the shelf 130 on the bias bolt 116 contacts the shelf 124 on the back mass 102, thereby applying a force to the back mass 102 along the axis AX toward the front mass 104. Further tightening the bias bolt 116 compresses the first ceramic disc 106 and the second ceramic disc 108 between the front mass 104 and the back mass 102. The bias bolt 116 can be tightened or loosened to adjust the amount of compression on the ceramic discs 106 and 108.

The electrodes connected to the discs 106 and 108 provide input ports to the resonators for a stimulating signal from an ultrasonic signal generator. In some embodiments of the transducer 100, the resonators may receive the stimulating signal via an electrically conducting front mass and/or an electrically conducting back mass, instead of or in addition to the electrodes. The resonator components within the transducer 100 spatially oscillate in one or more modes associated with the frequency of the applied stimulating signal. The transducer 100 transmits the spatial oscillations via the front mass as ultrasound, to (for example) a tank that contains a cleaning solution and an object to be cleaned.

According to one aspect of the present invention, prior to assembly with the discs under compression, at least one of the adjacent surfaces of the masses and the ceramic discs is curved, for example, having a concave shape extending about the central axis AX. As shown in FIG. 4A, in one preferred form, a bottom surface 402 of the back mass 102 and a top surface 404 of the front mass 104 are concave-shaped. In a preferred embodiment, where the diameter of elements 102, 106 and 108 is 1.50 inches, the center of the concave surface is preferably about 0.0002 inches to 0.001 inches deep.

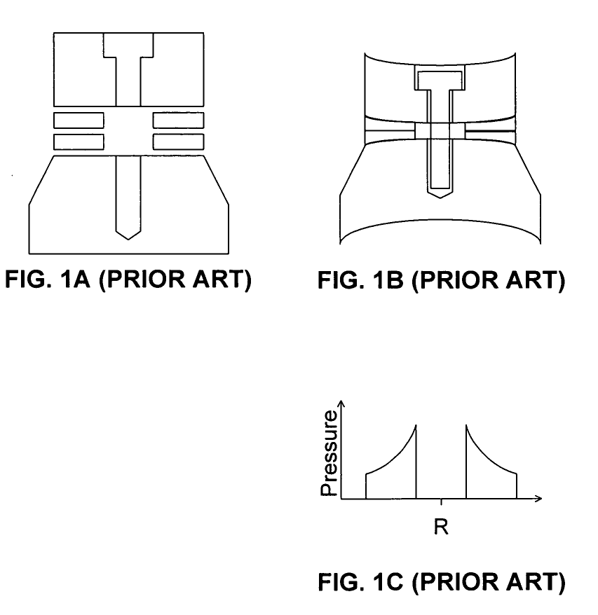

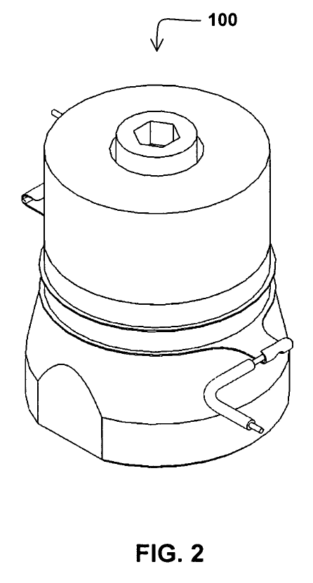

In use, when the central bias bolt 116 is tightened, the opposing surfaces 402 and 404 come together, compressing first the peripheral portions of the concave surfaces 402 and 404, and then the entire surfaces, when the bolt is fully tightened. The front and back masses 104 and 102 establish a desired compression of the discs 106 and 108, such that the pressure on the adjacent surfaces of the discs 106 and 108 (including a top surface 406 and a bottom surface 408) exerted by the front and back masses 104 and 102 is substantially evenly distributed across the surfaces 406 and 408 of the discs and the respective adjacent surfaces of the front and back masses. FIG. 4C schematically shows a chart of pressure across the surfaces 406 or 408 versus the radius R of the discs 106 or 108. As seen in FIG. 4C, the pressure on the surfaces 406 or 408 of the discs 106 or 108 is substantially uniform across the entire surface, however, in the prior art device, as shown in FIG. 1C, the pressure at regions close to the center of the discs is much higher than the pressure at the peripheral regions of the discs.

With the evenly distributed compressing pressure on the discs, at a given power, the operational reliability of the transducer is improved because lower localized compressive stress is seen by the inside diameter of the internal components during the compression half cycle and lower localized tensile stress is seen by the outside diameter of the internal components during the expansion half cycle of the transducer. These lower extremes in localized stresses significantly reduce fatigue related reliability issues. Also, as the localized pressure is substantially even across the adjacent surfaces of the resonator or resonators and other internal components, it is thereby possible to operate the transducer at higher powers because the maximum peak excursion capability is significantly higher, where the maximum peak excursion is defined as the difference between the maximum peak expansion half cycle and the maximum peak compression half cycle, and where the maximum peak expansion half cycle is the expansion distance that does not exceed the tensile yield strength of the resonator, resonators, or other internal components in any localized area, and where the maximum peak compressive cycle is the compression distance that does not exceed the compressive yield strength of the resonator, resonators, or other internal components in any localized area.

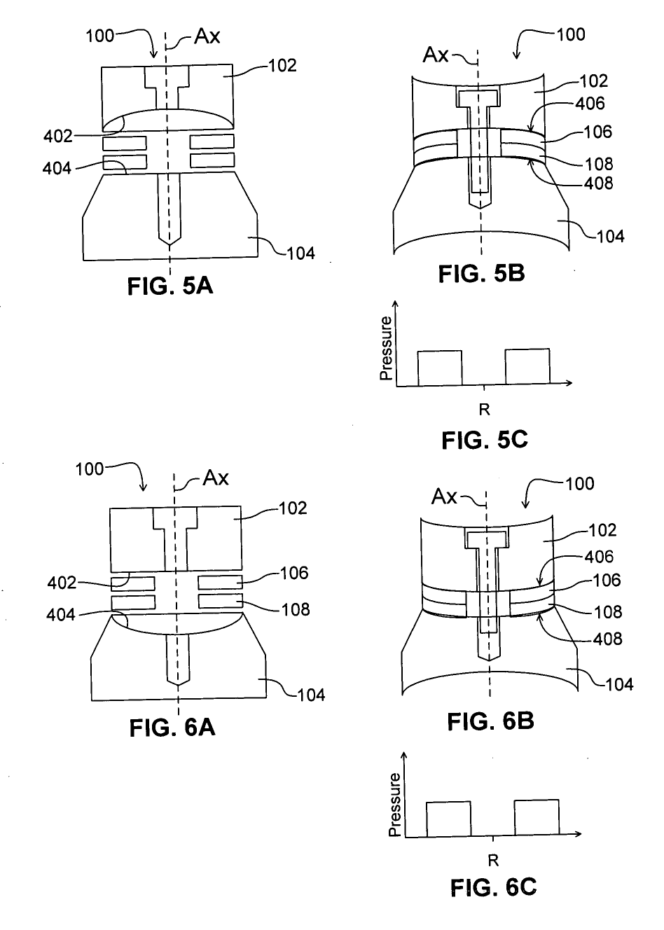

FIGS. 5A and 5B illustrate cross-sectional views of another preferred embodiment, in which the bottom surface 402 of the back mass 102 is concave-shaped and the top surface 404 of the front mass 104 is substantially flat. FIG. 5A depicts an exploded view to show the parts of the transducer 100. FIG. 5B depicts the transducer 100 under compression. FIG. 5C schematically shows a chart of pressure across the surfaces 406 or 408 of the ceramic discs versus the radius R of the discs 106 or 108. As seen in FIG. 5C, the pressure on the surfaces 406 or 408 of the discs 106 or 108 is substantially uniform across the entire surface.

FIGS. 6A and 6B illustrate cross-sectional views of a further preferred embodiment, in which the top surface 404 of the front mass 104 is concave-shaped and the bottom surface 402 of the front mass 102 is substantially flat. FIG. 6A shows an exploded view to show the parts of the transducer 100. FIG. 6B depicts the transducer 100 under compression. FIG. 6C schematically shows a chart of pressure across the surfaces 406 or 408 of the ceramic discs versus the radius R of the discs 106 or 108. As seen in FIG. 6C, the pressure on the surfaces 406 or 408 of the discs 106 or 108 is substantially uniform across the entire surface.

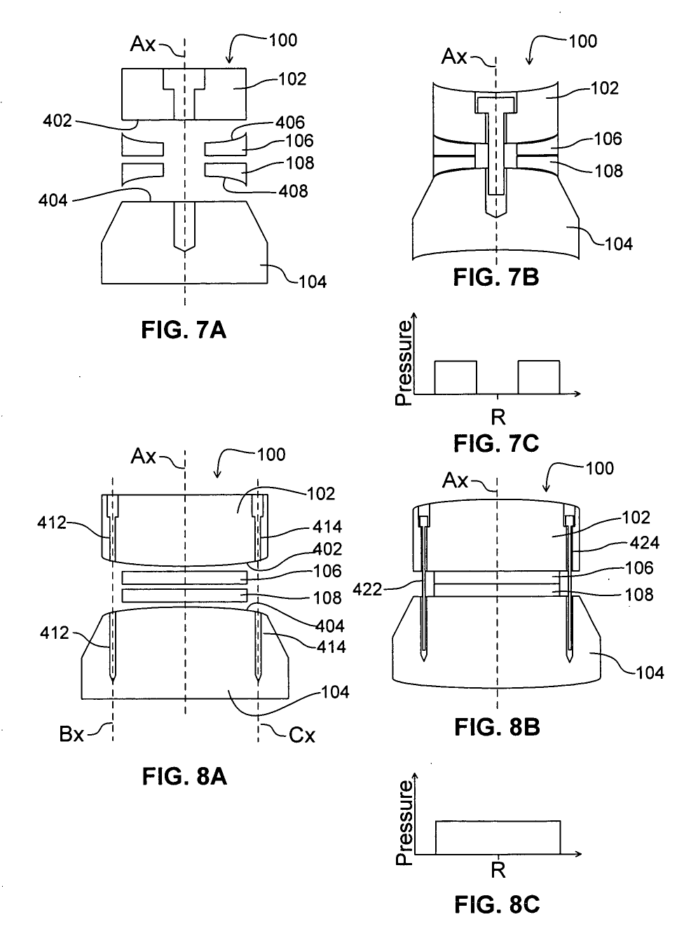

FIG. 7A illustrates a cross-sectional exploded view of another preferred embodiment, in which both of the top surface 406 of the first ceramic disc 106 and the bottom surface 408 of the second ceramic disc 108 are concave-shaped, and the bottom surface 402 of the back mass 102 and the top surface 404 of the front mass 104 are substantially flat. A person skilled in the art should appreciate that the transducer 100 may be implemented, in alternative forms which are not shown in the drawings, with only one of the top surface 406 and the bottom surface 408 of the discs is concave shaped. FIG. 7B shows a cross-sectional view of the transducer 100 when the central bolt 116 is tightened and the ceramic discs 106 and 108 are under compression. FIG. 7C schematically shows a chart of pressure across the surfaces 406 or 408 of the ceramic discs versus the radius R of the discs 106 or 108. As shown in FIG. 7C, the pressure on the surfaces 406 or 408 of the discs 106 or 108 is substantially uniform across the entire surface.

FIG. 8A illustrates a cross-sectional exploded view of a further preferred embodiment of the present invention. As shown in FIG. 8A, the transducer 100 includes a back mass 102, a front mass 104, a first ceramic disc 106 and a second ceramic disc 108, which are stacked so as to be adjacent and disposed along a common central axis AX. The first ceramic disc 106 and the second ceramic disc 108 are “sandwiched” between the back mass 102 and the front mass 104 and have relatively smaller diameter than the back mass 102 and the front mass 104. The front mass 104 and the back mass 102 define at least two elongated bores 412 and 414 at peripheral regions of the front mass 104 and the back mass 102. The elongated bores 412 and 414 extend along axes BX and CX, which are parallel to the central axis AX, and each include a first section defined in the back mass 102 and a second section defined in the front mass 104. The transducer 100 further includes at least two bias bolts 422 and 424 to be inserted into the elongated bores 412 and 414 to fasten back mass 102 and the front mass 104, as shown in FIG. 8B. The elongated bores 412 and 414 and the bias bolts 422 and 424 have a similar structure as the central bore and the central bias bolt 116 of the embodiments shown in FIGS. 4A-7C. Each of the bolts 422 and 424 includes a first end and a second end, and the second ends of the bolts include threads on the outer surface for mating with threads on the inner surfaces of the second sections of the bores 412 and 414, which are defined in the front mass 104. FIGS. 8A and 8B show only two bolts and two bores defined in the front and back masses. The transducer 100 preferably include three, or four, or more bolts, and the front and back masses define a corresponding number of bores at peripheral regions of the front and back masses for fastening the front and back masses.

As shown in FIG. 8A, prior to assembly with the discs under compression, both of the bottom surface 402 of the back mass 102 and the top surface 404 of the front mass 104 are preferably convex-shaped, extending about the central axis AX. A person skilled in the art should appreciate that the transducer 100 may be implemented, in other alternative forms which are not shown in the drawings, for example, with only one of the bottom surface 402 and the top surface 404 convex-shaped or with the top surface 406 of the first disc 106 and/or the bottom surface 408 of the second disc 108 convex-shaped.

The transducer 100 is assembled by passing the bias bolts 422 and 424 through the first sections of the bores in the back mass 102, and into the second sections of the bores 412 and 414 of the front mass 104. The threads on lead ends of the bias bolts 422 and 424 engage the threads in the bores 412 and 414 of the front mass 104. As the bias bolts 422 and 424 are tightened, the bias bolts 422 and 424 are drawn into the bores of the front mass 104, thereby applying a compressing force to the back mass 102 along the axes BX and CX toward the front mass 104. Further tightening the bias bolts 422 and 424 compress the first ceramic disc 106 and the second ceramic disc 108 between the front mass 104 and the back mass 102. The bias bolts 422 and 424 can be tightened or loosened to adjust the amount of compression on the ceramic discs 106 and 108.

When the bias bolts 422 and 424 are tightened, the opposing surfaces 402 and 404 come together, compressing first the central regions of the convex surfaces 402 and 404, and then the entire surfaces, when the bolts are fully tightened. The front and back masses 104 and 102 establish a substantially uniform compression against the discs 106 and 108, such that the pressure on the adjacent surfaces of the discs 106 and 108 (including a top surface 406 and a bottom surface 408) exerted by the front and back masses 104 and 102 is substantially evenly distributed across the entire surfaces 406 and 408 of the discs. FIG. 8C schematically shows a chart of pressure across the surfaces 406 or 408 of the ceramic discs versus the radius R of the discs 106 or 108. As shown in FIG. 7C, the pressure on the surfaces 406 or 408 of the discs 106 or 108 is substantially uniform across the entire surface.

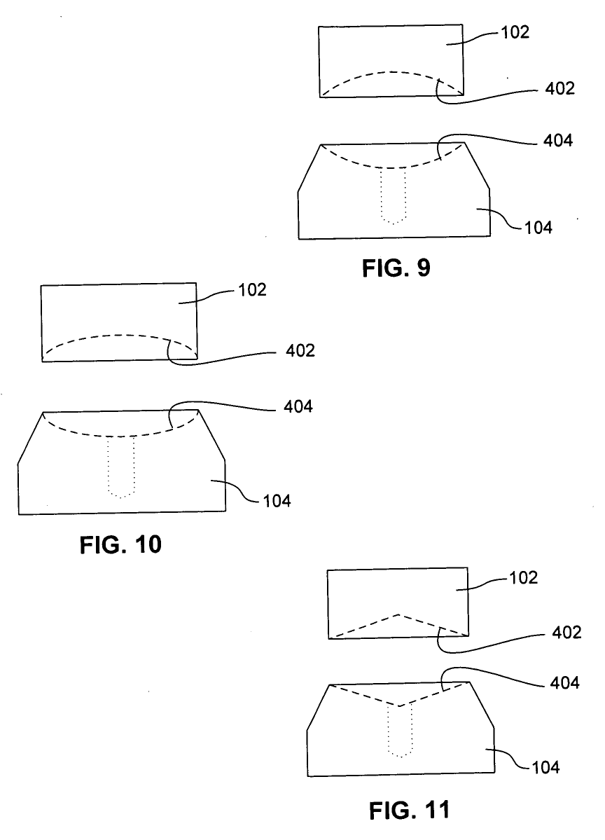

The concave-shaped or convex-shaped surfaces of the masses 102 and 104 and ceramic discs 106 and 108 in the embodiments shown in FIGS. 2-8C can be substantially spherical, conical, or embodying other suitable shapes. FIGS. 9-11 schematically show various exemplary embodiments of the shape of the concave surfaces. A person skilled in the art should appreciate that the shape of the concave or convex surfaces should not be limited to the embodiments shown in the drawings. In FIG. 9, the opposing top surface 404 and bottom surface 402 are substantially spherical-shaped. FIG. 10 illustrates an “ideal” curved shape of the opposing top surface 404 and bottom surface 402, which may be designed with computer analysis such that the curved surfaces 402 and 404 provide substantially evenly distributed pressure across the adjacent disc surfaces when the bolt is fully tightened and the front and back masses are under compression. In FIG. 11, the opposing top surface 404 and bottom surface 402 are substantially conical-shaped. A person skilled in the art should appreciate that other similar arrangements, although not depicted in the drawings, also can be used without departing from the concept of the present disclosure.

In the above-illustrated exemplary embodiments, the lead end of the bias bolt(s) is screwed into a threaded bore in the front mass for tightening the transducer assembly, so that the front mass acts as a “nut”. In alternative forms, the bore may extend through the front mass and a nut, which is a discrete element, is screwed onto the lead end of the bias bolt to tighten the transducer assembly. A person skilled in the art should also appreciate that other compression assemblies for tightening and compressing the front and back masses can be used to replace the bolt and nut assembly.

According to a further aspect of the present invention, the back mass 102 is fabricated from a low-density material (with respect to prior art back mass components) such as aluminum, magnesium, beryllium, titanium, or other similar materials known in the art, including alloys and other mixed composition materials. As used herein, the term “low density material” describes a material with a density of less than 6.0 grams per cubic centimeter (g/cc). In one preferred embodiment, the back mass 102 is made of type 7075-T651 aluminum, although other similar materials may also be used. In a preferred embodiment, the front mass 104 is made of type 2024 aluminum, although other similar materials may also be used. The back mass 102 and front mass 104 being made from different materials contributes to the ultrabroad bandwidth of the transducer 100. A low density back mass 104 results in a physically longer back mass, or a larger surface area as compared to a higher density back mass of the same acoustic length. The increased length (or larger surface area) further contributes to the multiple center frequencies of operation, and the ultrabroad bandwidth at each of the center frequencies. The disc resonators 106 and 108 are fabricated from a ceramic material that has been polarized via techniques well know in the art to imbue a piezoelectric effect. In other embodiments, the resonators may include other piezoelectric materials known in the art, such as natural piezoelectrics (e.g., quartz) or magnetorestrictives. Further, although the embodiment of FIGS. 2-8C includes two disc resonators, other embodiments of the transducer 100 may include a single resonator, or multiple (i.e., more than two) resonators.

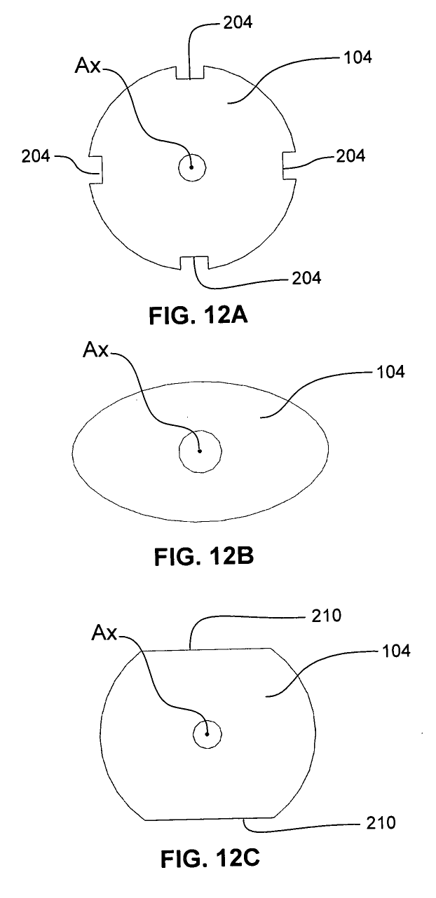

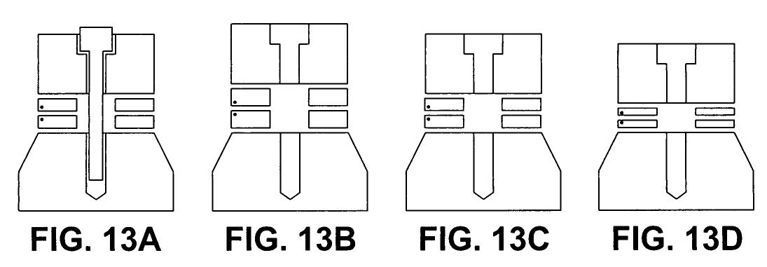

FIGS. 2 and 3 show that the transducer is cylindrically symmetrical about the central axis AX. Other embodiments of the transducer 100 may include transducer components that deviate from cylindrical symmetry, as shown for example in FIGS. 12A, 12B and 12C. The front mass 104 shown in cross section (in a plane perpendicular to the central axis AX) in FIG. 12A deviates from cylindrical symmetry by including lateral slots 204, each extending along axis parallel to the central axis AX, on the front mass 104. Another exemplary deviation from cylindrical symmetry is a front mass 104 with an elliptical cross section in a plane perpendicular to the central axis AX, as shown in FIG. 12B. A further exemplary deviation from cylindrical symmetry is a front mass 104 with flat regions 210 along the outer surface of the front mass, extending parallel to the central axis AX, as shown in FIG. 12C. In these exemplary embodiments, the back mass 102 and the ceramic discs 106 and 108, correspondingly, may embody the same or a similar shape as the front mass 104. Such deviations from cylindrical symmetry exemplified by the embodiments of FIGS. 12A, 12B and 12C result in transducer devices that have empirically demonstrated extremely wide bandwidth, and allow tailoring, manipulation or elimination of radial resonant frequencies. A large transducer bandwidth allows effective sweeping over a dramatically wide range of frequencies. The transducer described herein provides a substantially flat impedance versus frequency curve in the region of the transducer's resonance, or any of its overtones. This feature is intended to maximize the benefits obtained from the sweeping of frequencies within some bandwidth about some center frequency.

The transducer 100 can be operated at a dedicated single frequency, or it can be excited at multiple frequencies, i.e., at the transducer fundamental frequency and/or any of its higher frequency overtones. The size and geometry of the ceramic disc resonators 106 and 108 can be tailored to ensure that the radial resonant frequencies of the resonators coincide with that of the transducer assembly for maximized output at that frequency. In yet another embodiment, the size and geometry of the resonators can be tailored to ensure that the radial resonant frequencies of the resonators do not coincide with that of the transducer assembly, in order to minimize strain on the transducer at those frequencies.

While the above-described embodiments establish a substantially uniform pressure across the resonator surface(s), the desired pressure profiles (as a function of radius about the central axis) may be achieved by changing the geometry of the curved surface(s).

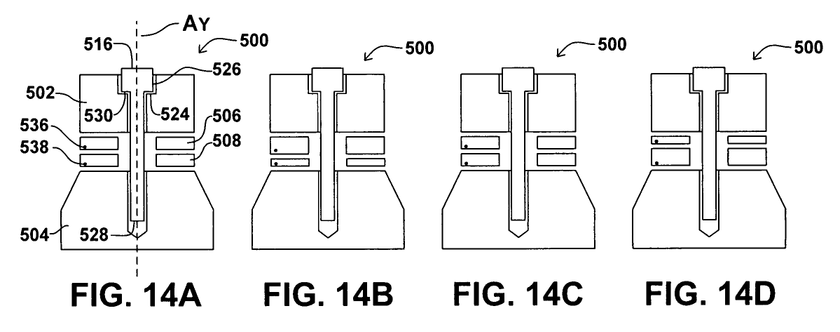

FIG. 14A shows a cross-sectional view of a transducer 500 according to one preferred embodiment of the present invention. FIG. 14B shows a cross-sectional view of transducer 500 when transducer 500 is driven to 90 degrees of the stimulating signal. FIG. 14C shows a cross-sectional view of transducer 500 when transducer 500 is driven to 180 degrees of the stimulating signal. FIG. 14D shows a cross-sectional view of transducer 500 when transducer 500 is driven to 270 degrees of the stimulating signal. The transducer 500 employs a Langevin architecture, also known in the art as a sandwich transducer. According to one embodiment of the invention, the transducer 500 as shown in FIG. 14A includes a back mass 502, a front mass 504, a resonator assembly including a first polarized piezoelectric ceramic 506 with a positive polarity indicated by a dot 536 near its bottom surface and a second polarized piezoelectric ceramic 508 with a positive polarity indicated by a dot 538 near its bottom surface, and a compression assembly including a central bias bolt 516. The transducer may further include an insulator, which is not shown in the drawings, disposed between the bolt 516 and the polarized piezoelectric ceramics 506 and 508, and electrodes (not shown) in any of four known configurations and connected to the polarized piezoelectric ceramics 506 and 508. In the embodiment of FIGS. 14A to 14D, spaces are drawn between individual parts, for example, between 502 and 506, between 506 and 508, between 508 and 504 and between the head of bolt 516 and its mating surface in the back mass 502. These spaces are drawn for clarity, in the actual compressed sandwich transducer assembly the respective surfaces are pressed together by the force of the compression assembly. This force is typically in the range of 500 to 10,000 pounds, insuring contact of the surfaces and compression of the polarized piezoelectric ceramics. The back mass 502, front mass 504, first polarized piezoelectric ceramic 506 and second polarized piezoelectric ceramic 508 are each characterized by a substantially annular shape extending about a central axis AY with the positive polarity surfaces indicated by dots 536 and 538 each oriented toward the front mass 504. A two wire stimulating signal is applied to transducer 500 with the first wire connected to the center junction where the positive polarity surface of polarized piezoelectric ceramic 536 is adjacent to the negative polarity surface of polarized piezoelectric ceramic 538. The second wire supplying the stimulating signal is connected to the two remaining surfaces of polarized piezoelectric ceramics 506 and 508. When the stimulating signal is a sine waveform on the first wire, a maximum positive value of voltage occurs at the 90 degree position of the sine wave, this drives transducer 500 to the condition shown in FIG. 14B, where polarized piezoelectric ceramic 506 has increased in thickness and polarized piezoelectric ceramic 508 has decreased in thickness. This action of the polarized piezoelectric ceramics 506 and 508 results in substantially zero net displacement which reduces losses in the transducer 500 and allows the under damped condition at higher overtone frequencies. These higher overtone frequencies in the higher microsonics and megasonic frequency ranges become usable.

In the embodiment shown in FIGS. 14A to 14D, the bore of the front mass 504, does not extend completely through the front mass 504 along the axis AY. Other embodiments may include an inner bore of the front mass 504 that extends completely through the front mass 504. The front mass 504 further includes threads on the walls of the inner bore. In one preferred embodiment, the threads are machined into the inner bore, although other techniques known in the art may also be used to create threads in the inner bore.

The back mass 502, front mass 504, first polarized piezoelectric ceramic 506 and second polarized piezoelectric ceramic 508 are stacked so as to be adjacent and disposed along the common central axis AY, as shown in FIGS. 14A to 14D. The first polarized piezoelectric ceramic 506 and the second polarized piezoelectric ceramic 508 are “sandwiched” between the back mass 502 and the front mass 504. The bias bolt 516 is preferably symmetrically disposed about the common axis AY, and includes a first end 526 and a second end 528. The outer radius near first end 526 is characterized by an abrupt change, forming a shelf 530. The second end 528 includes threads along the outer surface for mating with the threads on the walls of the inner bore of the front mass 504. The transducer 500 is assembled by passing the bias bolt 516 through the bore of the back mass 502, the bore of the first polarized piezoelectric ceramic 506, the bore of the second polarized piezoelectric ceramic 508, and into the bore of the front mass 504. The threads on the bias bolt 516 engage the threads in the bore of the front mass 504. As the bias bolt 516 is tightened, the bias bolt 516 is drawn into the bore of the front mass 504, and the shelf 530 on the bias bolt 516 contacts the shelf 524 on the back mass 502, thereby applying a force to the back mass 102 along the axis AY toward the front mass 504. Further tightening the bias bolt 516 compresses the first polarized piezoelectric ceramic 506 and the second polarized piezoelectric ceramic 508 between the front mass 504 and the back mass 502. The bias bolt 516 can be tightened or loosened to adjust the amount of compression on the polarized piezoelectric ceramics 506 and 508.

Electrodes connected to the polarized piezoelectric ceramics 506 and 508 provide input ports to the polarized piezoelectric ceramics for a stimulating signal from an ultrasonic signal generator. In some embodiments of the transducer 500, the polarized piezoelectric ceramics may receive the stimulating signal via an electrically conducting front mass and/or an electrically conducting back mass, instead of or in addition to the electrodes. The polarized piezoelectric ceramic components within the transducer 500 spatially oscillate in one or more modes associated with the frequency of the applied stimulating signal. The transducer 500 transmits the spatial oscillations via the front mass as ultrasound, to (for example) a tank that contains a cleaning solution and an object to be cleaned.

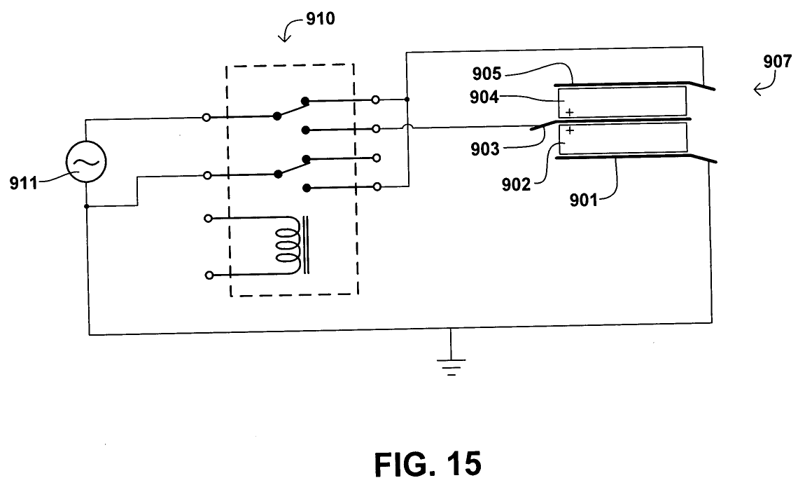

FIG. 15 shows another embodiment of the invention where a resonator assembly 907 and a relay 910 are configured for two modes of operation. The resonator assembly 907 is constructed with a stack of five components in the following order and orientation, bottom electrode 901 is adjacent to the negative polarized surface of polarized piezoelectric ceramic 902 which has its positive polarized surface adjacent to the center electrode 903, which is adjacent to the positive polarized surface of polarized piezoelectric ceramic 904, which has its negative polarized surface adjacent to the top electrode 905. This resonator assembly 907 is configured for use in a sandwich type transducer by use of a relay 910. When the relay 910 is in the deenergized condition, it is said to be in a first state. When relay 910 is energized, it is said to be in a second state. This embodiment of the invention provides two modes of operation. In a first mode, where the relay is in the first state, a sandwich type transducer using this resonator assembly can be operated at the low loss high frequencies made possible by the present invention. In a second mode, where the relay is in the second state, a sandwich type transducer using this resonator assembly can be operated at the half wave fundamental resonant frequency of a conventional transducer.

Another advantage to the embodiment of the invention shown in FIG. 15 is the series and parallel connections of the polarized piezoelectric ceramics. In the first state of relay 910 where the resonator assembly 907 is operating at higher frequencies, e.g., higher microsonics and megasonic frequencies, the polarized piezoelectric ceramics are in series which causes the capacitance of the resonator assembly to be one-half of that of a single polarized piezoelectric ceramic. This low capacitance has an advantage at high frequencies because corresponding inductive components within a generator producing a high frequency stimulating signal 911 are of a practical size and value. Another advantage is that the currents needed to drive the resonator assembly are reduced by the lower capacitance. In the second state of relay 910 where the resonator assembly 907 is operating at the half wave resonant fundamental frequency or possibly at other resonant harmonic or overtone frequencies, the polarized piezoelectric ceramics are in parallel which provides a lower impedance and lower drive voltages at these lower frequencies. 01301 It will be clear to a person skilled in the art that other switching devices can be used in place of relay 910 in FIG. 15. For example, triacs can used to switch the stimulating signals to the proper electrodes in resonator assembly 907.

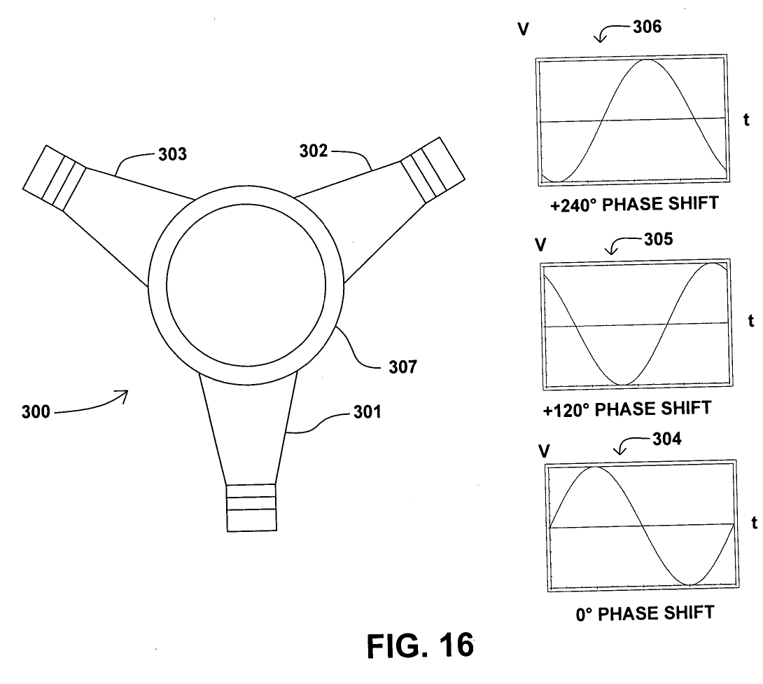

FIG. 16 shows another embodiment of the invention that provides for low loss bonding of a transducer front mass to a radiating surface. Apparatus 300 in FIG. 16 consists of three ultrasonic metal welding horns 301, 302 and 303 that are driven by ultrasonic signals 304, 305 and 306, respectively. The three ultrasonic signals are each 120 degrees out of phase with each other, for example, signal 304 has an equation sin wt, signal 305 has an equation sin (wt+120 degrees) and signal 306 has an equation sin (wt+240 degrees), where w is the angular frequency of the signals and t is time.

The three ultrasonic horns are spaced 120 degrees apart around the front mass 307 of an ultrasound transducer that is to be bonded to a radiating surface. When signals 304, 305 and 306 are applied to the ultrasonic horns, front mass 307 is scrubbed in a circular motion against the radiating surface (not shown) and a metallic bond is formed as is known in the ultrasonic metal welding industry. Having the signals out of phase creates a circular scrubbing motion, rather than a linear action currently used in metal welding. The bond formed with the circular action has lower loss than the epoxy bonds that are used to attach ultrasound transducers to radiating surfaces, therefore giving the bonded transducer lower loss and improved high frequency performance.

While three horns are shown in the preferred embodiment, it is contemplated that other arrangements may be used depending on the size of the area to be welded. Thus, rather than having three transducers that are 120 degrees out of phase, it is contemplated that four transducers that are 90 degrees out of phase could be used, or that five transducers that are 72 degrees out of phase could be used. By using additional transducers with a corresponding reduction in the degree by which the transducers are out of phase, additional power can be added without having to use more powerful transducers. Not only is this welding technique useful for welding a transducer front mass to a radiating surface, but it also could have application in metal welding in general.

In another embodiment, an invar front driver 703 or an invar interface between a transducer and a quartz tank 707 is used to allow direct bonding to quartz without cracking the quartz due to large thermal expansion differences. Invar, or FeNi 36, is an alloy of iron and nickel having a particularly low coefficient of thermal expansion (CTE).

In another embodiment, the tank or the radiating surfaces 707 of these structures are made with low internal friction sheet metal material, such as maraging steel, to obtain efficient operation of thicker tanks and immersibles at higher frequencies. Such low internal friction materials transmit energy better with fewer losses and heat generation.

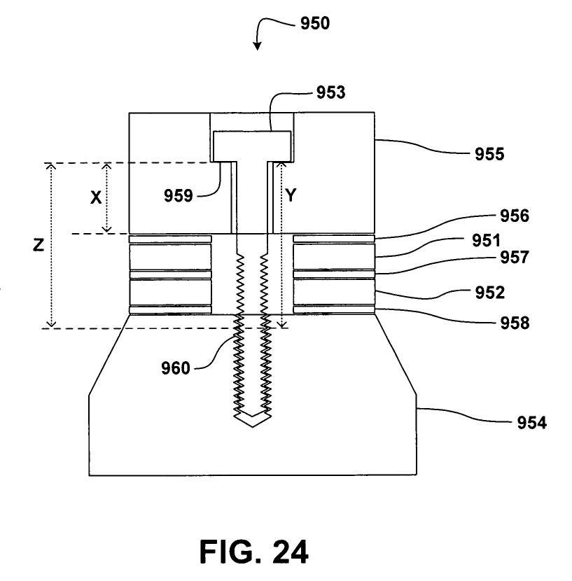

In another embodiment, mathematical design parameters based on the thermal expansion coefficients of the transducer materials are used, resulting in zero static pressure change on the piezoelectric ceramic when transducer temperature is changed. In order to provide such a zero thermal expansion design for a Langevin transducer, the following design example for the transducer shown in FIG. 24 may be used. Those skilled in the art will be able to apply the following design principles to other transducers.

In FIG. 24 the transducer 950 design parameter x (resulting in zero static pressure change on the piezoelectric ceramics 951 and 952 when temperature is changed) is based on designing equal thermal expansion of the stretched section y of bias bolt 953 and the portions of the transducer (designated as z in FIG. 24) that are compressed by bias bolt 953. The thermal expansion coefficient used for the 2024 aluminum alloy front driver 954 is 12.9 ppm/deg F. The thermal expansion coefficient used for the 7075-T6 aluminum alloy back mass 955 is 12.9 ppm/deg F. The thermal expansion coefficient used for the alloy steel bias bolt 953 is 6.5 ppm/deg F. The thermal expansion coefficient used for the nickel electrodes 956, 957 and 958 is 6.5 ppm/deg F. The thermal expansion coefficient used for the piezoelectric ceramics 951 and 952 is 0.0 ppm/deg F., because the thermal expansion coefficient for PZT-4 at 50 deg C. is +1.7 ppm/deg C. and at 100 deg C. it is −1.0 ppm/deg C. This averages out to zero over a typical operating temperature range. The stretched bias bolt 953 length equals x+0.01+0.2+0.01+0.2+0.01+0.125=0.555+x, where x is the length of that part of the 7075-T6 aluminum back mass 955 between the bottom of the top bore 959 and the electrode surface on the back mass as shown in FIG. 24, where 0.01 is the thickness of a nickel electrode (there are three nickel electrodes), where 0.2 is the thickness of a piezoelectric ceramic (there are two piezoelectric ceramics), and where 0.125 is the assumed depth into the 2024 aluminum front driver that the bias bolt exerts its force on threads 960. The bias bolt 953 expansion equals (0.555+x)*6.5 per deg F., where the 10 to the minus 6 factor was left out for clarity. The compressed portion of the transducer assembly expansion equals x*12.9+0.03*6.5+0*0.4+0.125*12.9=1.8075+12.9x. Since it is required that the thermal expansion of each of these members is equal, set the two expressions equal to each other and solve for x.
(0.555+x)*6.5=1.8075+12.9x
x=0.28125 inches
When the back mass 955 is designed to have a bore depth that leaves 0.28128 inches of aluminum for the bias bolt 953 to pass through, there is zero thermal stress change on the piezoelectric ceramics 951 and 952 when the temperature of transducer 950 changes.

In another embodiment, a thermally conductive fluid or other substance such as a gel, is built into the center cavity of a center bolt Langevin transducer shown in FIG. 4 such that the thermally conductive substance conducts heat from the inner diameter of the ceramics 106/108 and from the back mass 102 to the front mass 104.

In another embodiment (not shown), a nut or threaded insert is cast into an aluminum front mass to minimize thread creep compared to that which occurs with softer aluminum threads. The threaded insert may be cast iron or steel and is harder or less malleable than the softer aluminum body of the front mass.

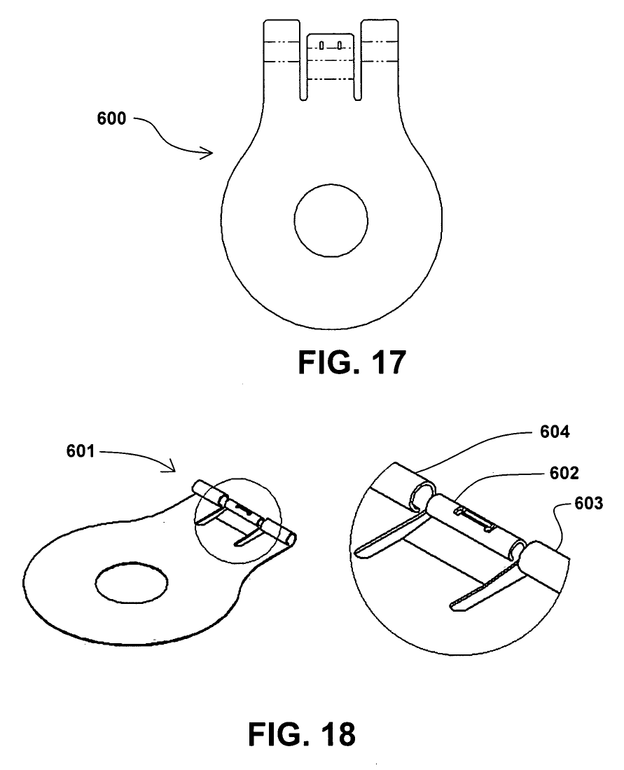

FIG. 17 shows a first form of a sub-component of the invention consisting of a crimped electrode 600 with strain relief of the insulated electrode wires (not shown). This first form is the electrode in the pre-crimped state. FIG. 18 shows electrode 601 which is electrode 600 after the electrical crimp 602 and insulation strain relief 603 and 604 are formed. This electrode configuration allows the high currents that typically are needed to drive the inventive transducer to be reliably supplied while preventing breakage of the wires because of the ultrasonic vibrations which this electrode is subjected to. As shown in FIGS. 17 and 18, strain relief 603 and 604 are formed by crimping the electrode to the insulated portion of the wire. The curled ends of portions 603 and 604 have a slightly larger diameter to accommodate crimping to the insulated portion of the wire. By engaging the insulated portion of the wire, less strain is applied to the wire. A central portion 602 is also provided. As shown, this portion is curled and has an internal diameter that is less than the internal diameter of portions 603 and 604. Portion 602 is adapted to be crimped directly to the conductive wire and forms the electrical connection. The outer ends of portion 602 are adapted to hold the copper wire but not to deform or strain the wire. The middle of portion 602 is crimped to provide an electrical connection. By having the wires extend with insulation through strain relief portions 603 and 604, less strain is felt by the wire and the wire does not bend as much when attached or with use.

It is also contemplated that an ultrasonic weld of the electrode to the wire may be used. Thus, instead of or in addition to crimping the center portion 602 to the wire, a metallurgical bond is provided by ultrasonically welding portion 602 to the wire. This is particularly adapted for use with higher frequency and higher current connections. In addition or instead, it is also contemplated that a solder or brazing material may be applied to the connection to provide a unified joint. This assists in lowering the resistance of the connection and increasing the stability for high frequency ultrasounds where high currents are flowing through the wire.

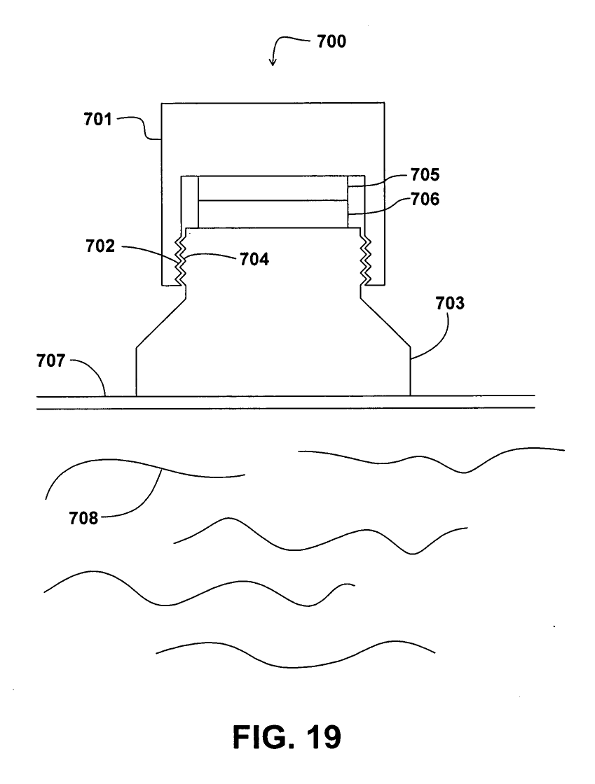

FIG. 19 shows an alternate ultrasound transducer compression assembly configuration that improves the cooling of the piezoelectric ceramic in a high frequency transducer.

Ultrasound transducer 700 is constructed such that back mass 701 with internal threads 702 is connected to front mass 703 at external threads 704. This configuration supplies the compressive bias to piezoelectric ceramics 705 and 706 and conducts heat from ceramic 705 into back mass 701, then the heat is conducted through threads 702 and 704 into front mass 703 where the heat is efficiently conducted through the radiating surface 707 into the liquid 708. Thus, back mass 701 is in direct threaded engagement with first mass 703, and no bolt and throughbore arrangement is used. This allows for greater thermal conductivity from the back mass to the front mass, which provides the advantage of moving heat generated from operation of the transducer from the back mass, which does not have an adjacent heat sink, to the front mass, which is connected to tank 707 and liquid 708, which operate as a heat sink.

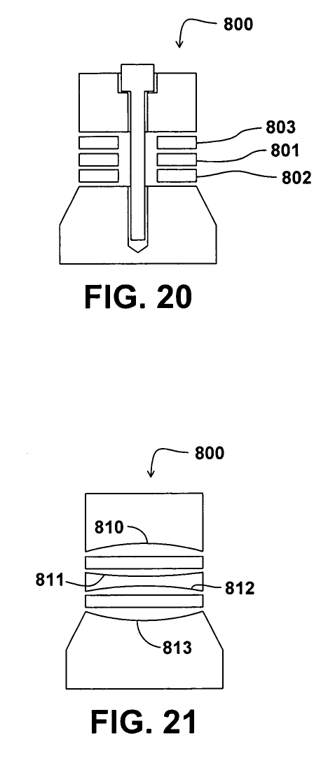

FIG. 20 shows an ultrasound transducer 800 with a heat conducting middle mass 801 between two piezoelectric ceramics 802 and 803. In a conventional Langevin transducer where the piezoelectric ceramics are adjacent or separated by a thin electrode, heat conduction from this area is poor and over heating can occur, especially in higher frequency transducers. The transducer 800 reduces this heating by using middle mass 801 as a heat sink to cool ceramics 802 and 803. It is also contemplated that high sink mass 801 may also include fins (not shown), which increase the surface area and therefore the heat dissipation value of middle mass 801.

FIG. 21 shows an exploded cross-sectional diagram of ultrasound transducer 800 from FIG. 20, but in this FIG. 21 configuration, the four surfaces 810, 811, 812 and 813 that make contact with the piezoelectric ceramics are concave in shape to give substantially equal pressure across the piezoelectric surfaces when the transducer is biased into compression. This further improves performance and reliability of high frequency overtone transducers.

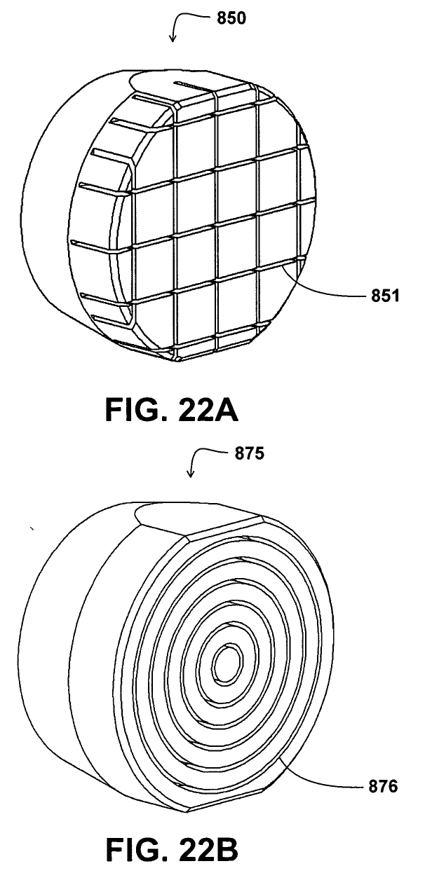

FIG. 22A shows a transducer front mass 850 with a grid 851 cut into the bonding surface. This grid 851 is bonded to low thermal expansion surfaces (not shown) like quartz and the grid 851 reduces the stress that can crack quartz during temperature changes. As shown, by cutting a grid 851 into the bonding surface, the total surface is divided into multiple segments. These segments can be sized so that they have a surface area that is less than the critical area, which is the surface area that will result in stresses from heat cracking the material to which the surface is bonded. Thus, the area of each segment is reduced to the level required such that the coefficient of thermal expansion of the entire surface is reduced to the extent required such that it does not crack the tank to which it is bonded. By reducing the area over which bonding occurs, the tolerance for expansion because of heat is increased. The surface area of each segment is provided as a function of the tolerance of the material to which the bonding surface is bonded, such as quartz.

FIG. 22B shows a transducer front mass 875 with concentric circles 876 cut into the bonding surface, rather than a grid. Again, these concentric circles 876 are bonded to low thermal expansion surfaces (not shown) like quartz and the concentric circles 876 reduce the stress that can crack quartz during temperature changes.

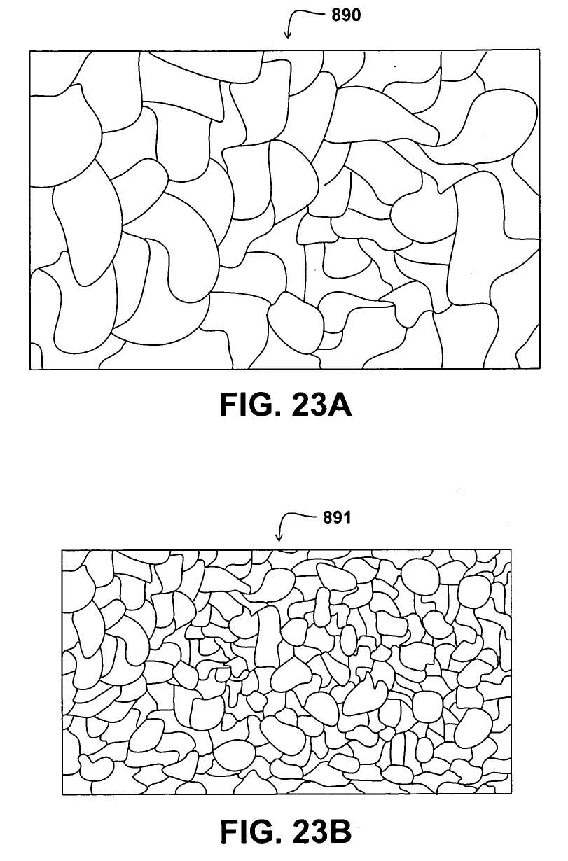

FIG. 23A shows a picture of grain structure of aluminum typically used in Langevin transducers and FIG. 23B shows a picture of improved grain structure according to the invention. Picture 890 with typical grain structure causes energy loss when this type of aluminum is used in high frequency ultrasound transducers. By using the fine grain structure of picture 891, the losses are reduced and higher frequency operation is possible.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A sandwich type ultrasound transducer comprising:
a resonator assembly having a first surface, a second surface, a first active element driven by a stimulating signal and a second active element driven by a stimulating signal;
a front mass having a front surface adjacent to said first surface of said resonator assembly;
a back mass having a back surface adjacent to said second surface of said resonator assembly;
electrodes configured to transmit said stimulating signal to said active elements;
a compression assembly coupling said front mass and said back mass, and adapted to compress said resonator assembly;
wherein said first active element is driven to decrease in thickness while said second active element is driven to increase in thickness when said simulating signal is transmitted by said electrodes;
wherein at least one of said surfaces is curved when said resonator assembly is not compressed by said compression assembly; and
wherein said curvature is a function of a desired pressure profile across said surfaces of said resonator assembly when compressed by said compression assembly.

2. The ultrasound transducer set forth in claim 1, wherein said desired pressure profile is substantially uniform across said surfaces of said resonator assembly.

3. The ultrasound transducer according to claim 1, wherein said front mass further comprises a bonding surface ultrasonically welded to a radiating surface.

4. The ultrasound transducer set forth in claim 1, wherein said front mass comprises an iron and nickel alloy.

5. The ultrasound transducer set forth in claim 1, wherein said front mass comprises an iron and nickel alloy bonding surface.

6. The ultrasound transducer set forth in claim 4, wherein said front mass consists essentially of an iron and nickel alloy.

7. The ultrasound transducer set forth in claim 1, wherein said front mass comprises an iron and nickel alloy or an iron and nickel bonding surface that has a coefficient of thermal expansion that is substantially similar to the coefficient of thermal expansion of quartz, whereby said first mass may be better bonded to a quartz radiating surface.

8. The ultrasound transducer set forth in claim 1, wherein said front mass or said back mass consists essentially of low internal friction material.

9. The ultrasound transducer set forth in claim 8, wherein said low internal friction material is selected from a group consisting of niobium, maraging steel and single crystal silicon.

10. The ultrasound transducer according to claim 1, wherein said front mass comprises a bonding surface bonded to a radiating surface and said radiating surface is constructed of a low internal friction material.

11. The ultrasound transducer set forth in claim 1, wherein said compression assembly and said resonator assembly are adapted to provide substantially no static pressure change on said active elements when heated during use.

12. The ultrasound transducer set forth in claim 1, wherein:
said compression assembly comprises a bore in said active elements and said front and back masses, and a rod extending through said bore;
and further comprising a thermally conductive fluid in said bore;
whereby said fluid conducts heat to said front mass.

13. The ultrasound transducer set forth in claim 1, wherein said front mass comprises an aluminum portion and a threaded portion of a material harder than said aluminum portion.

14. The ultrasound transducer set forth in claim 1, wherein said electrode comprises a first portion adapted to engage an insulated portion of a conducting wire and a second portion adapted to directly engage an uninsulated portion of said conducting wire.

15. The ultrasound transducer set forth in claim 14, wherein said second portion comprises a middle portion adapted to crimp said conducting wire.

16. The ultrasound transducer set forth in claim 14, wherein said electrode is soldered to a conducting wire.

17. The ultrasound transducer set forth in claim 14, and further comprising a conductive wire ultrasonically welded to said electrode.

18. The ultrasound transducer set forth in claim 1, wherein said front mass has a threaded surface, said back mass has a threaded surface corresponding to said front mass threaded surface, and wherein said surfaces are in threaded engagement such that rotation of one of said masses relative to the other causes said masses to move closer together or further apart.

19. The ultrasound transducer set forth in claim 1, and further comprising a heat sink mass between said first active element and said second active element of said resonator assembly.

20. The ultrasound transducer set forth in claim 19, wherein said heat sink mass further comprises at least one fin adapted to radiate heat.

21. The ultrasound transducer set forth in claim 19, wherein said heat sink mass comprises a first surface and said first surface is curved when said resonator assembly is not compressed by said compression assembly, and wherein said curvature is a function of said desired pressure profile across said surfaces of said resonator assembly when compressed by said compression assembly.

22. The ultrasound transducer set forth in claim 21, wherein said pressure profile is substantially uniform across said surfaces of said resonator assembly.

23. The ultrasound transducer set forth in claim 1, wherein said front mass comprises a bonding surface having a total bonding area and said bonding surface comprises multiple intersecting grooves dividing said surface into multiple segments, each of said segments having a surface area less than said total bonding surface.

24. The ultrasound transducer set forth in claim 23, wherein said segments form a rectangular grid.

25. The ultrasound transducer set forth in claim 23, wherein said segments are annular.

26. The ultrasound transducer set forth in claim 23, wherein said bonding surface consists essentially of aluminum and is bonded to quartz.

27. The ultrasound transducer set forth in claim 1, wherein said front mass or said back mass comprises aluminum having a fine grain structure.

28. An ultrasound transducer comprising:
a resonator assembly having a first surface and a second surface;
a front mass having a front surface adjacent to said first surface of said resonator assembly;
a back mass having a back surface adjacent to said second surface of said resonator assembly;
a compression assembly coupling central regions of said front mass and said back mass, and adapted to compress said resonator assembly;
wherein said front mass or said back mass consists essentially of a low internal friction material to reduce losses and obtain higher frequencies.

29. The ultrasound transducer set forth in claim 28, wherein said material is selected from a group consisting of niobium, maraging steel and single crystal silicon.

30. The ultrasound transducer set forth in claim 28, wherein at least one of said surfaces is concave-shaped when said resonator assembly is not compressed by said compression assembly, and wherein said curvature is a function of a desired pressure profile across said surfaces of said resonator assembly when compressed by said compression assembly.

31. The ultrasound transducer set forth in claim 28, wherein said front mass comprises an invar bonding surface that has thermal expansion characteristics substantially the same as quartz.

32. The ultrasound transducer set forth in claim 28, wherein said front mass comprises a bonding surface ultrasonically welded to a radiating surface.

33. The ultrasound transducer set forth in claim 28, wherein said front mass comprises a bonding surface with a grid pattern or concentric circles.

34. A sandwich type ultrasound transducer driven by an integer number n greater than one stimulating signals comprising:
a resonator assembly having a first surface and a second surface and containing an integer number p of driven active elements where p divided by n is an integer;
a front mass having a surface adjacent to said first surface of said resonator assembly;
a back mass having a surface adjacent to said second surface of said resonator assembly;
electrodes configured to transmit said n stimulating signals to said p number of driven active elements;
a compression assembly coupling said front mass and said back mass, and adapted to compress said resonator assembly;
wherein said p number of driven active elements are driven in a zero displacement phase shifted drive voltages configuration by said n number of stimulating signals to suppress a half wave resonant frequency and to reduce loss and enhance operation at higher frequencies above said half wave resonant frequency;
wherein at least one of said surfaces is curved when said resonator assembly is not compressed; and
wherein said curvature is a function of a desired pressure profile across said surfaces of said resonator assembly when compressed by said compression assembly.
